(19) United States
(12) Patent Application Publication
(10) Pub. No.: US 2026/0223105 A1
(43) Pub. Date: Jul. 30, 2026

(54) RESOURCE ALLOCATION OF SIDELINK POSITIONING REFERENCE SIGNAL IN A RESOURCE POOL

(71) Applicant: INTEL CORPORATION, Santa Clara, CA (US)

(72) Inventors: Gang XIONG, Portland, OR (US); Debdeep CHATTERJEE, San Jose, CA (US); Sergey PANTELEEV, Kildare (IE); Kilian ROTH, Munich (DE)

(73) Assignee: INTEL CORPORATION, Santa Clara, CA (US)

(21) Appl. No.: 19/145,778

(22) PCT Filed: Dec. 7, 2023
(86) PCT No.: PCT/US2023/082938

§ 371 Date: Jul. 3, 2025

Related U.S. Application Data
(60) Provisional application No. 63/446,178, filed on Feb. 16, 2023.
(60) Provisional application No. 63/492,683, filed on Mar. 28, 2023.
(60) Provisional application No. 63/494,969, filed on Apr. 7, 2023.
(60) Provisional application No. 63/509,195, filed on Jun. 20, 2023.

(51) Int. Cl. H04W 72/1263; H04L 5/00; H04W 72/40

(52) U.S. Cl. CPC H04W 72/1263; H04L 5/0051; H04W 72/40

(57) ABSTRACT

Various embodiments herein provide techniques related to a sidelink positioning reference signal (SL PRS). In some embodiments, the SL PRS may be multiplexed with information related to one or more other SL channel on resources of a resource pool that is related to SL transmission. The multiplexed SL PRS and information related to the one or more other SL channel may then be transmitted. Other embodiments may be described and/or claimed.

### CROSS REFERENCE TO RELATED APPLICATION

The present application claims priority to U.S. Provisional Patent Application No. 63/446,178, which was filed Feb. 16, 2023; U.S. Provisional Patent Application No. 63/492,683, which was filed Mar. 28, 2023; U.S. Provisional Patent Application No. 63/494,969, which was filed Apr. 7, 2023; and to U.S. Provisional Patent Application No. 63/509,195, which was filed Jun. 20, 2023.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of sidelink positioning, in accordance with various embodiments.

FIG. 2 illustrates an example of multiplexing of a physical sidelink shared channel (PSSCH), a physical sidelink control channel (PSCCH), and a sidelink positioning reference signal (SL PRS) in a resource pool, in accordance with various embodiments.

FIG. 3 illustrates an alternative example of multiplexing of a PSSCH, a PSCCH, and a SL PRS in a resource pool, in accordance with various embodiments.

FIG. 4 illustrates an alternative example of multiplexing of a PSSCH, a PSCCH, and a SL PRS in a resource pool, in accordance with various embodiments.

FIG. 5 illustrates an alternative example of multiplexing of a PSSCH, a PSCCH, and a SL PRS in a resource pool, in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 illustrates a network in accordance with various embodiments.

FIG. 10 depicts an example procedure for practicing the various embodiments discussed herein.

FIG. 11 depicts another example procedure for practicing the various embodiments discussed herein.

FIG. 12 depicts another example procedure for practicing the various embodiments discussed herein.

FIG. 13 depicts another example procedure for practicing the various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, which may be referred to as a fifth generation (5G) and/or new radio (NR) system, may be expected to provide access to information and sharing of data anywhere, anytime by various users and applications. NR may be considered to be a unified network/system that is intended to meet vastly different and sometime conflicting performance dimensions and services. Such diverse multi-dimensional requirements may be driven by different services and applications. In general, NR is expected to evolve based on third generation partnership project (3GPP) long term evolution (LTE)-Advanced (collectively, “LTE-A”) technology, with additional potential new Radio Access Technologies (RATs) to enrich people lives with better, simple, and seamless wireless connectivity solutions. NR may enable wireless connections that may deliver fast, rich contents and services.

NR supports highly precise positioning in the vertical and horizontal dimensions, which relies on timing-based, angle-based, power-based, or hybrid (e.g., some combination thereof) techniques to estimate the user location in the network. In particular, the following RAT-dependent positioning techniques may be used to meet the positioning requirements for various use cases, e.g., indoor, outdoor, Industrial internet of thing (IT), etc.
Downlink time difference of arrival (DL-TDOA)
Uplink time difference of arrival (UL-TDOA)
Downlink angle of departure (DL-AoD)
Uplink angle of arrival (UL AoA)
Multi-cell round trip time (multi-RTT).
NR enhanced cell ID (E-CID)

With wide bandwidth for positioning signal and beamforming capability in millimeter wave (mmWave) frequency band (which may also be referred to as a frequency range 2 or FR2 band, and may refer to frequencies between approximately 24.25 gigahertz (GHz) and 52.6 GHz), higher positioning accuracy can be achieved by RAT dependent positioning techniques. Note that in the 3GPP release-16 (Rel-16) specifications, the downlink positioning reference signal (DL-PRS) and uplink sounding reference signal (UL-SRS) for positioning may be used to enable/achieve target performance characteristics.

In release-18 (Rel-18), in order to address use cases such as autonomous driving, sidelink or vehicle-to-everything (V2X) based positioning are considered. More specifically, various scenarios including in-coverage, partial coverage, out of network coverage may be considered for sidelink positioning. To meet the positioning accuracy requirement, it is envisioned that a new sidelink reference signal, i.e., sidelink position reference signal (SL PRS) can be introduced.

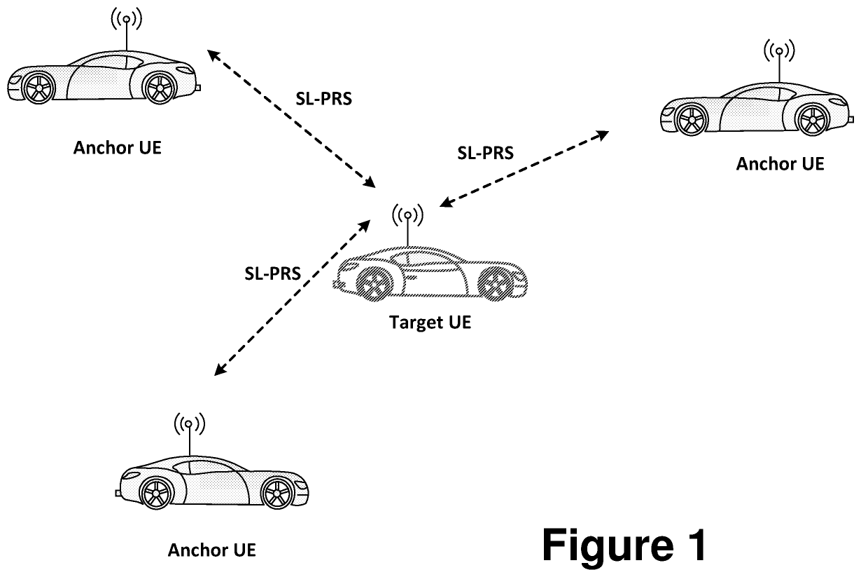

FIG. 1 illustrates one example of sidelink positioning with anchor user equipments (UEs) and a target UE. In the example, a target UE may indicate the UE to be positioned while anchor UEs indicate the UEs supporting positioning of target UE, e.g., by transmitting and/or receiving SL PRS and providing positioning-related information. Note that SL PRS can be transmitted between anchor and target UEs for sidelink positioning.

For sidelink positioning, SL PRS can be either transmitted in a dedicated SL PRS resource pool or a shared SL PRS resource pool, where a sidelink resource pool which can be used for transmission of both SL PRS and PSSCH will be referred to as a shared SL PRS resource pool, and a sidelink resource pool which can be used for transmission of SL PRS and cannot be used for transmission of PSSCH will be referred to as dedicated SL PRS resource pool. Further, a sidelink control information (SCI) format in the resource pool may be used to allocate the resource for SL PRS transmission. In order to ensure proper operation, certain mechanisms may be defined for resource allocation of SL PRS in a resource pool.

Embodiments herein relate to resource allocation of the SL PRS in a resource pool.

### Resource Allocation of SL PRS in a Resource Pool

As mentioned above, in order to address use cases such as autonomous driving, sidelink or vehicle-to-everything (V2X) based positioning are considered. More specifically, various scenarios including in-coverage, partial coverage, out of network coverage may be considered for sidelink positioning. To meet the positioning accuracy requirement, it is envisioned that a sidelink reference signal, i.e., sidelink position reference signal (SL PRS) may be used.

For sidelink positioning, SL PRS can be either transmitted in a dedicated SL PRS resource pool or a shared SL PRS resource pool. Further, a sidelink control information (SCI) format in the resource pool may be used to allocate the resource for SL PRS transmission. In order to ensure proper operation, certain mechanisms may be defined for resource allocation of SL PRS in a resource pool.

Embodiments of resource allocation of SL PRS in a resource pool for SL PRS transmission are provided as follows:

In one embodiment, in a resource pool for SL PRS transmission, SL PRS can be multiplexed with other SL channels and/or signals in a Time Division Multiplexing (TDM) manner. In some aspects, the other SL channels and/or signals may include physical sidelink control channel (PSCCH), physical sidelink shared channel (PSSCH) and/or associated demodulation reference signal (DMRS) transmission. In addition, the resource pool may be the dedicated SL PRS resource pool and/or shared SL PRS resource pool.

In one option, SL PRS can be multiplexed with PSCCH and PSSCH and associated DMRS in a resource pool in a TDM manner. In some aspects, PSCCH is used to carry a first stage sidelink control information (SCI) while PSSCH is used to carry a second stage SCI only. In this case, no Sidelink Shared Channel (SL-SCH) is included in the PSSCH.

In this case, one bit field may be included in the first stage SCI to indicate whether SL-SCH is carried by PSSCH. In particular, bit “1” may be used to indicate that SL-SCH is present in the PSSCH while bit “0” may be used to indicate that SL-SCH is not present in the PSSCH. To ensure backward compatibility, the one bit field may be included in the reserved bits in the first stage SCI format. Alternatively, whether SL-SCH may be carried by PSSCH or not may be (pre-)configured per resource pool.

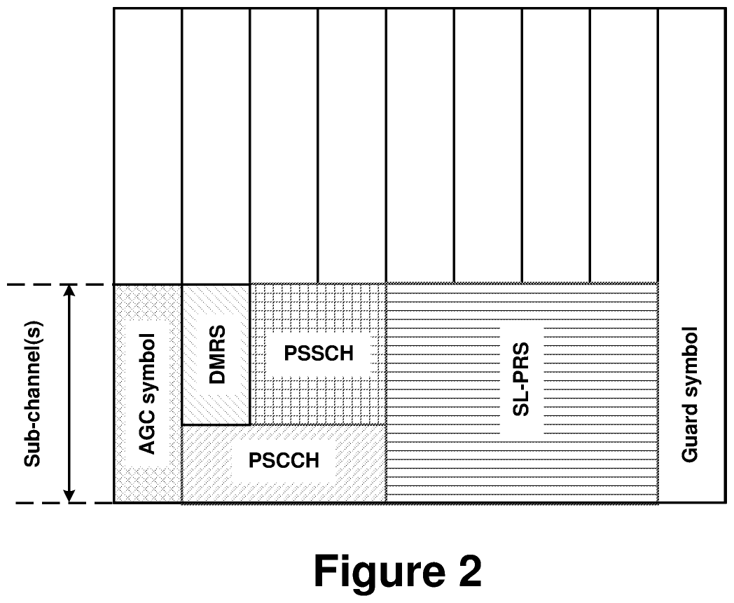

In another embodiment, the PSSCH carrying the second stage SCI may be only allocated in the symbols where PSCCH is located, and occupies the remaining resource that is not allocated for PSCCH transmission in the subband(s) for PSSCH-PSCCH transmissions, which is indicated in the first stage SCI. This may be depicted in FIG. 2.

In an example of the embodiment, the duration of a PSSCH multiplexed with SL PRS in a slot may be shorter than the minimum duration of PSCCH defined for the SL bandwidth part (BWP) given by (sl-LengthSymbols-2) where sl-LengthSymbols is provided by higher layers. For instance, the duration of a PSSCH multiplexed with SL PRS may be same as the number of symbols of an associated PSCCH. Furthermore, in an example, the demodulation reference signal (DMRS) associated with such a PSSCH may be limited to a single DMRS symbol and located in the first symbol of PSSCH transmission after an automatic gain control (AGC) symbol. In this case, SL PRS is transmitted after the PSCCH symbols and occupies the subbands indicated in the first stage SCI. Alternatively, the DMRS associated with such a PSSCH may be limited to two DMRS symbols and located in the first and fifth symbols of PSSCH transmission after AGC symbol. In this case, SL PRS is transmitted after the PSCCH symbols and occupies the subbands indicated in the first stage SCI such that the SL PRS is mapped to consecutive-in-time symbols except for the second PSSCH DMRS symbol.

FIG. 2 illustrates one example of multiplexing of PSSCH, PSCCH and SL PRS in a resource pool. In the example, PSSCH carrying a second stage SCI is allocated in the remaining resource in the sub-channels which are not used for PSCCH transmissions and located in the same symbol as PSCCH transmission. Further, the first symbol is allocated for DMRS associated with PSSCH transmission. SL PRS is transmitted after the PSCCH and PSSCH in the resource pool.

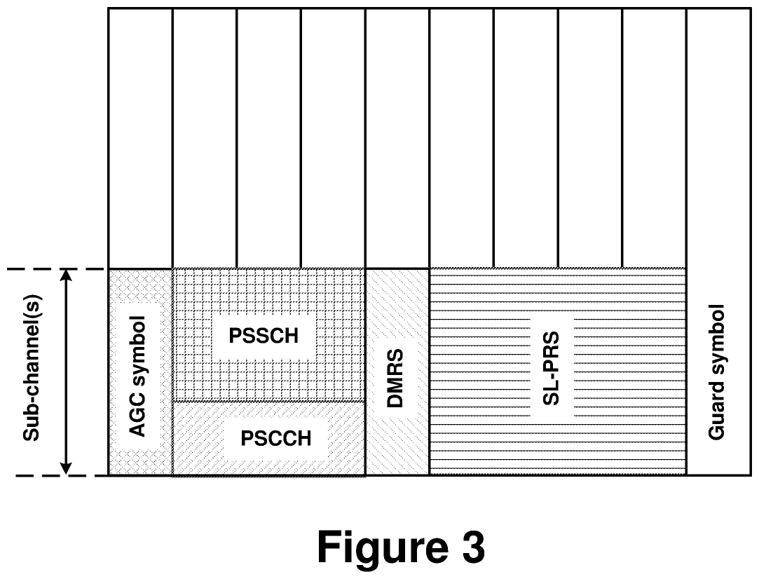

In another option, if DMRS is not present in the symbols where PSCCH is located, DMRS symbol may be inserted right after the PSCCH symbols. In this case, in one example PSSCH may be associated with a single-symbol DMRS located right after the last PSCCH symbol and a SL PRS may be transmitted after the PSSCH DMRS symbol and occupy the subbands indicated in the first stage SCI. This may be depicted in FIG. 3.

FIG. 3 illustrates one example of multiplexing of PSSCH, PSCCH and SL PRS in a resource pool. In the example, PSSCH carrying a second stage SCI is allocated in the remaining resource in PRBs which are not used for PSCCH transmissions and located in the same symbol as PSCCH transmission. Further, DMRS associated with PSSCH transmission is transmitted after PSSCH and PSCCH symbol. SL PRS is transmitted after the PSCCH, PSSCH and associated DMRS in the resource pool.

In some aspects, when SL PRS is multiplexed with PSSCH and PSCCH in a resource pool, SL PRS occupies the remaining symbols in a slot within the resource pool, excluding the last symbol that is reserved for guard symbol.

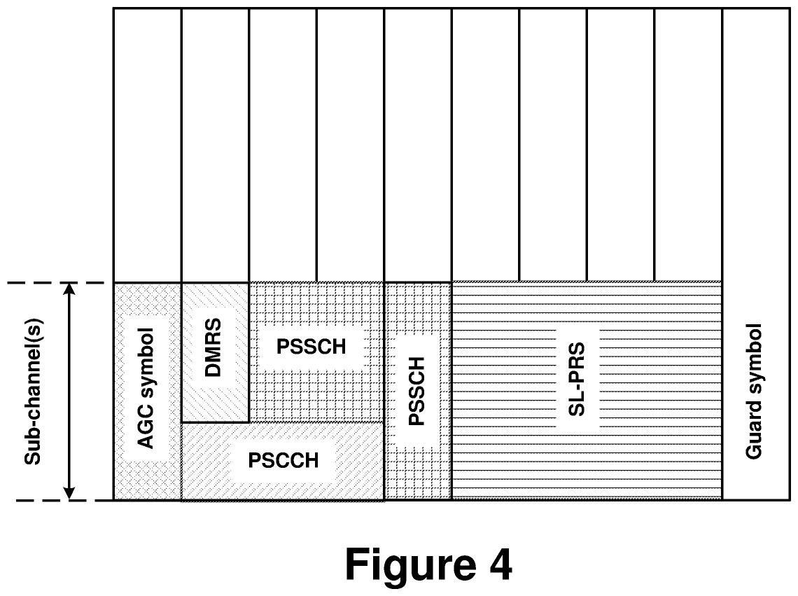

In another embodiment, the PSSCH carrying the second stage SCI may be allocated in the symbols where PSCCH is located or the symbols after the PSCCH transmissions. When the PSSCH is allocated after PSCCH transmission, the PSSCH occupies all sub-channels that are indicated in the first stage SCI. This may be depicted in FIG. 4.

In one option of the embodiment, the number of symbols allocated for PSSCH transmissions may be shorter than the minimum duration of PSSCH defined for the SL BWP given by (sl-LengthSymbols-2) where sl-LengthSymbols is provided by higher layers. Furthermore, the number of symbols for PSSCH may be indicated in the first stage SCI. In some aspects, the field for indication of the number of symbols may be located in the reserved bits in the first stage SCI.

In another option, the number of symbols allocated for PSSCH transmissions can be determined in accordance with the number of symbols allocated for the resource pool, DMRS associated with PSSCH, PSCCH, SL PRS, automatic gain control (AGC) and guard symbol for Tx and Rx turnaround time. In one example, assuming one symbol is allocated for AGC and guard symbol, respectively, and 10 symbols for the resource pool with a slot as indicated via higher layer parameter sl-LengthSymbols, 3 symbols for PSCCH transmission, 4 symbols for SL PRS transmission and 1 symbol for DMRS associated with PSSCH transmission, in this case, the number of symbols allocated for PSSCH transmission can be determined as 3.

In a further example, SL PRS may be mapped to a slot in a shared SL PRS resource pool following the last symbol of the PSSCH in the slot.

In another option, the number of additional symbols allocated for PSSCH after PSCCH transmission can be dynamically indicated in the first stage SCI. In some aspects, the field for indication of the number of additional symbols may be located in the reserved bits in the first stage SCI. In one example, one bit indicator in the first stage SCI may be used to indicate whether 0 or 1 additional symbol is allocated for PSSCH transmission after PSCCH.

In another option, the number of symbols allocated for PSSCH may be determined as the minimum integer number of PSSCH symbols used to carry the calculated number of REs for 2^{nd} stage SCI according to the equation for the number of coded modulation symbols as per clause 8.4.4, 3GPP technical specification (TS) 38.212. Example changes to the equation are presented below.

As a further extension, one bit indicator in the first stage SCI may be used to indicate whether 0 or N additional symbol is allocated for PSSCH transmission after PSCCH, where value N can be (pre-)configured by higher layers.

In another option, the number of symbols for PSSCH or the number of additional symbols for PSSCH after PSCCH can be dynamically indicated in the first stage SCI. More specifically, when UE determines that the PSSCH is only used to carry second stage SCI, in accordance with the indication whether SL-SCH is carried by PSSCH and/or whether a new second stage SCI format for scheduling SL PRS is indicated by the first stage SCI, some of the fields in the first stage SCI may be repurposed to indicate the number of symbols for PSSCH or the number of additional symbols for PSSCH after PSCCH. In some aspects, some of the fields may include at least one or more following fields: beta_offset indicator, modulation and coding scheme, additional MCS table indicator, PSFCH and overhead indication.

FIG. 4 illustrates one example of multiplexing of PSSCH, PSCCH and SL PRS in a resource pool. In the example, PSSCH carrying a second stage SCI is allocated in the remaining resource in the sub-channels which are not used for PSCCH transmissions. Based on the indication in the first stage SCI, one additional symbol is used for PSSCH transmission. SL PRS transmission is after PSSCH in the resource pool.

In another embodiment, the amount of resource allocated for the second stage SCI is calculated based on the legacy equation as defined in Section 8.4.4 in 3GPP TS 38.212 [1]. Further, the determined number of coded modulation symbols generated for 2nd-stage SCI transmission is aligned with the symbol boundary within the sub-channel, which is indicated by the first stage SCI.

In particular, for 2nd-stage SCI transmission on PSSCH with SL-SCH, the number of coded modulation symbols generated for 2nd-stage SCI transmission prior to duplication for the 2nd layer if present, denoted as Q′_{SCI2}, is determined as follows:

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ α {\sum }_{l = 0}^{{N}_{symbol}^{PSSCH} - 1} {M}_{sc}^{SCI 2} ( l ) ⌉ \} + γ$$

where.
   γ is the number of vacant resource elements in the resource blocks within the sub-channels of the last PSSCH symbol to which the last coded symbol of the 2^{nd}-stage SCI belongs.

$${M}_{s c}^{SCI 2} ( l )$$

is the number of resource elements that can be used for transmission of the 2nd-stage SCI in OFDM symbol l,

$${M}_{s c}^{SCI 2} ( l ) = {M}_{s c}^{PSSCH} ( l ) - {M}_{s c}^{PSCCH} ( l ) - {M}_{s c}^{S L - PRS} ( l ) , where {M}_{s c}^{S L - PRS} ( l )$$

scheduled bandwidth of SL PRS transmission, expressed as a number of subcarriers.
L_{SCI2} is the CRC field length for 2^{nd} stage SCI which may be reused as 24 bit or may be reduced to a smaller value depending on the payload size of the 2^{nd} stage SCI for positioning

Note that other parameters in the equation above may be defined in Section 8.4.4 in 3GPP TS 38.212 [1].

When multiple different SL PRS configurations are configured in a shared SL PRS resource pool, based on (pre)-configuration the value of

$${M}_{s c}^{S L - P R S} ( l )$$

is a (pre)-configured amount of resource or

$${N}_{s y m b o l}^{S L - P R S}$$

is a pre-configured number of symbols for SL PRS resource, or the minimum or maximum amount of SL PRS REs dependent on all potential SL PRS configurations (pre)-configured in the resource pool.

In another embodiment, the resource calculation of the 2^{nd} stage SCI is changed in the shared SL PRS resource pool only for the case of the new 2^{nd} stage SCI format that contains information about the SL PRS. A new formula for the calculation of the resource for 2^{nd} stage SCI is defined.

In one example the beta offset values are reinterpreted for the new 2^{nd} stage SCI format. In this case for each beta offset value a fixed amount of percentage of resource including SL PRS REs is (pre)-configured per resource pool. Note that this calculation can consider either the actual number of REs used for SL PRS, a (pre)-configured amount of resource for SL PRS resource, or the minimum or maximum amount of SL PRS REs dependent on all potential SL PRS configurations (pre)-configured in the resource pool.

In another example instead of calculating the resource of the 2^{nd} stage SCI relative to the code rate signalled by the MCS, the beta offset is applied relative to spectral efficiency of the transmission. Note that in this case it may be desirable to ensure that the 2^{nd} stage SCI does not have a too high code rate, as its may use quadrature phase shift keying (QPSK) modulation.

The first example updates the current formula to consider number of spatial layers and modulation format of PSSCH. The update for the amount of resource elements for 2^{nd} stage SCI in Clause 8.4.4 in 3GPP TS 38.212 can be given as follows

For 2nd-stage SCI transmission on PSSCH with SL-SCH, the number of coded modulation symbols for 2nd-stage SCI transmission, denoted as Q′_{SCI2}, is determined as follows:

$${Q}_{SCI 2}^{′} = min \{ ⌈ \frac{( {O}_{SCI 2} + {L}_{SCI 2} ) \cdot {β}_{offset}^{SCI 2} \cdot v \cdot \frac{{Q}_{m}}{2} {\sum }_{l = 0}^{{N}_{symbol}^{P S S C H} - 1} {M}_{s c}^{SCI 2} ( l )}{{\sum }_{r = 0}^{{C}_{S L - SCH} - 1} {K}_{r}} ⌉ , ⌈ α {\sum }_{l = 0}^{{N}_{symbol}^{PSSCH} - 1} {M}_{sc}^{SCI 2} ( l ) ⌉ \} + γ$$

where
   O_{SCI2} is the number of bits for the SCI format 0-2
   L_{SCI2} is the number of CRC bits for SCI format 0-2.

$${β}_{offset}^{SCI 2}$$

is indicates in the corresponding SCI format 0-1.
C_{SL-SCH} is the number of code blocks for SL-SCH of the PSSCH transmission.

$${M}_{s c}^{PSSCH} ( l )$$

is the scheduled bandwidth of PSSCH transmission, expressed as a number of subcarriers;
Alternatively, it is a default/nominal scheduled bandwidth which takes into account actual number of PRB variation if reminder PRBs after sub-channelization are considered. It could be the bandwidth used for TBS determination for this TB

$${M}_{s c}^{DMRS} ( l )$$

is the number of subcarriers in OFDM symbol l that carries DMRS, in the PSSCH transmission. Alternatively, the maximum configured density of DMRS can be considered.

$${M}_{s c}^{P T - R S} ( l )$$

is the number of subcarriers in OFDM symbol l that carries PT-RS, in the PSSCH transmission.

$${M}_{s c}^{SCI 2} ( l ) = {M}_{s c}^{PSSCH} ( l ) - {M}_{s c}^{D M R S} ( l ) - {M}_{s c}^{P T - R S} ( l ) - {M}_{s c}^{CSI - RS} ( l )$$

Alternatively, l=0, 1, 2 . . . ,

$${N}_{symbol}^{{PSSCH}^{′}} - 1 ,$$

where

$${N}_{symbol}^{{PSSCH}^{′}}$$

is the number of symbols for PSSCH except AGC and for the case when PSFCH is present-Alternatively, l=0, 1, 2 . . . ,

$${N}_{symbol}^{{PSSCH}^{′}} - 1 ,$$

where

$${N}_{symbol}^{{PSSCH}^{′}}$$

is the number of symbols for PSSCH except AGC and for the case when PSFCH is not present
Alternatively, l=0, 1, 2 . . . ,

$${N}_{symbol}^{{PSSCH}^{′}} - 1 ,$$

where

$${N}_{symbol}^{{PSSCH}^{′}}$$

is the number of symbols for PSSCH used for TBS determination for this PSSCH
v is the number of spatial layers for the PSSCH
Qₘ is the modulation order of the PSSCH
γ is the number of otherwise vacant resource elements in the resource block to which the last coded symbol of the SCI format 0-2 belongs.
Kᵣ is the r-th code block size for SL-SCH of the PSSCH transmission.
α is configured by higher layer parameter [SL-scaling].

In another example, the update for the amount of resource elements for 2^{nd} stage SCI in Clause 8.4.4 in 3GPP TS 38.212 can be given as follows

For 2^{nd}-stage SCI transmission on PSSCH with SL-SCH, the number of coded modulation symbols for 2^{nd}-stage SCI transmission, denoted as Q′_{SCI2}, is determined as follows:

$${Q}_{SC I 2}^{′} = min \{ ⌈ ( {O}_{SCI 2} + {L}_{SCI 2} ) ) \cdot {β}_{offset}^{SCI 2} min \{ \frac{{\sum }_{l = 0}^{{N}_{{symbol}^{- 1}}^{PSSCH}} {M}_{sc}^{SCI 2} ( l )}{{\sum }_{r = 0}^{{C}_{SL - SCH} - 1} {K}_{r}} , \frac{1}{{s}_{max}} \} ⌉ , ⌈ α {\sum }_{l = 0}^{{N}_{symbol}^{PSSCH} - 1} {M}_{sc}^{SCI 2} ( l ) ⌉ \} + γ$$

where
   O_{SCI2} is the number of the SCI format 0-2 bits
   L_{SCI2} is the number of CRC bits for SCI format 0-2, which is [xxx] bits.

$${β}_{offset}^{SCI 2}$$

is indicated in the corresponding SCI format 0-1.
C_{SL-SCH} is the number of code blocks for SL-SCH of the PSSCH transmission.

$${M}_{s c}^{P S S C H} ( l )$$

is the scheduled bandwidth of PSSCH transmission, expressed as a number of subcarriers; excluding reminder PRB and a possibly configured PSFCH.

$${M}_{s c}^{DMRS} ( l )$$

is the number of subcarriers in OFDM symbol l that carries DMRS, in the PSSCH transmission. Possibly considering the reminder PRB and/or the maximum density of all configured DMRS patterns.

$${M}_{s c}^{P T - RS} ( l )$$

is the number of subcarriers in OFDM symbol l that carries PT-RS, in the PSSCH transmission. Possibly only considering PT-RS not in reminder PRBs

$${M}_{s c}^{SCI 2} ( l ) = {M}_{s c}^{PSSCH} ( l ) - {M}_{s c}^{DMRS} ( l ) - {M}_{s c}^{PT - RS} ( l ) - {M}_{s c}^{CSI - RS} ( l )$$

sₘₐₓ is the maximum allowed spectral efficiency for the 2^{nd} stage PSCCH
γ is the number of otherwise vacant resource elements in the resource block to which the last coded symbol of the SCI format 0-2 belongs.
Kᵣ is the r-th code block size for SL-SCH of the PSSCH transmission.
α is configured by higher layer parameter [SL-scaling].

In another example, using the nominal PSSCH spectral efficiency instead would solve the problem of the dependency on the TBS

$${Q}_{SCI2}^{′} = ⌈ ( {O}_{SCI2} + {L}_{SCI2} ) \cdot {β}_{offset}^{SCI 2} min \{ \frac{1}{v {Q}_{m} r} , \frac{1}{{s}_{max}} \} ⌉ + γ$$

where
   O_{SCI2} is the number of the SCI format 0-2 bits
   L_{SCI2} is the number of CRC bits for SCI format 0-2, which is [xxx] bits.

$${β}_{offset}^{SCI 2}$$

is indicated in the corresponding SCI format 0-1.
v number of spatial layers for the PSSCH
Qₘ modulation order of the PSSCH
r nominal code rate of the PSSCH according to the used MCS
sₘₐₓ is the maximum allowed spectral efficiency for the 2^{nd} stage PSCCH
γ is the number of otherwise vacant resource elements in the resource block to which the last coded symbol of the SCI format 0-2 belongs.
α is configured by higher layer parameter [SL-scaling].

In one embodiment, a UE is not expected to be provided with sidelink resource pool configuration that leads to number of required PSSCH symbols to carry 2^{nd} stage SCI together with the number symbols for other configured signals, e.g., SL PRS, PSCCH, PSFCH, AGC, Gap to exceed the configured sidelink slot length indicated via higher layer parameter sl-LengthSymbols.

In one embodiment, the above embodiments and examples, and/or other embodiments herein, may only apply to a resource pool that is dedicated for SL PRS transmission.

In another embodiment, same bandwidth can be allocated for PSSCH, PSCCH and SL PRS transmission. In this case, DMRS associated with PSCCH transmission can be used for the channel estimation of PSSCH. Further, DMRS associated with PSSCH may not be used.

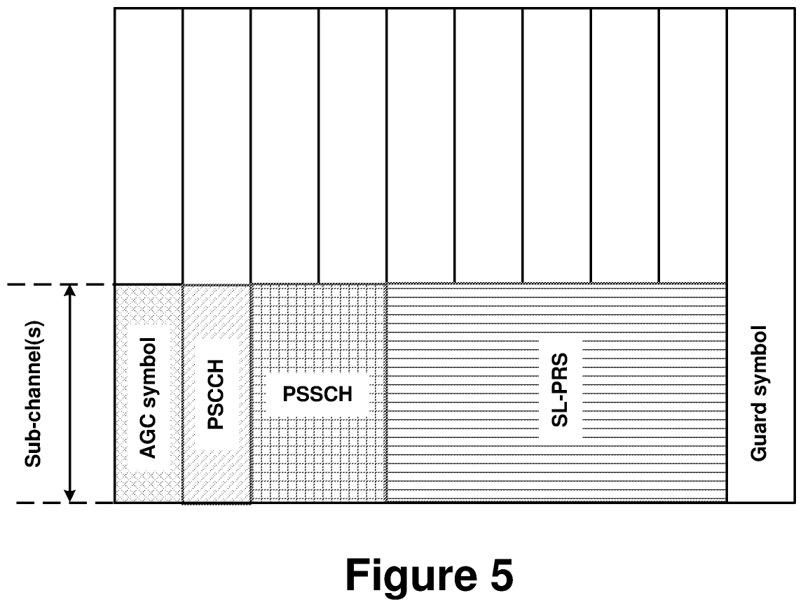

FIG. 5 illustrates one example of multiplexing of PSSCH, PSCCH and SL PRS in a resource pool. In the example, PSSCH carrying a second stage SCI is allocated in the remaining resource in the sub-channels which are not used for PSCCH transmissions. The PSSCH transmission is based on PSCCH DMRS and limited to single layer transmission.

In another embodiment, the transmission of the PSSCH is limited to single layer transmission. The coderate as well as the modulation order for the PSSCH can be either indicated in the first stage via traditional MCS signaling or pre-configured. The related beta offset for the 2^{nd} stage SCI can also be dynamically signaled in the first stage SCI or (pre)-configured in the resource pool configuration.

In another embodiment, all information to decode the PSSCH that is based on PSCCH DMRS are signaled in the first stage SCI.

In another embodiment, when SL-SCH is carried by PSSCH, and when SL PRS is scheduled in the shared SL PRS resource pool and associated with PSSCH, transport block size (TBS) may be determined in accordance with the number of symbols allocated for SL PRS transmission. In particular, one field in the first stage SCI format may be used to indicate whether SL PRS overhead is used to determine TBS for PSSCH transmission. Alternatively, a combination of a codepoint for the bit field to indicate the second stage SCI format and/or another field in first stage SCI may be used to indicated whether SL PRS overhead is used to determine TBS for PSSCH transmission. In an example of this alternative option, the codepoint for the second stage SCI format may indicate a second stage SCI format for a UE (pre-)configured to receive SL PRS and used for scheduling of SL PRS transmission. In some aspects, a codepoint for 2^{nd} stage SCI format indication in the 1^{st} stage SCI with “11” may be used to indicate the new 2^{nd} stage SCI format, e.g., SCI format 2-D.

Further, when the first stage SCI format indicates that SL PRS overhead is used to determine TBS for PSSCH, the number of symbols for SL PRS transmission may be included in the equation for TBS determination, where the number of symbols for SL PRS transmission may be (pre-)configured by the higher layers or derived from SL PRS configurations parameters.

In some aspects, the one bit field in the first stage SCI format that is used to indicate whether SL PRS overhead is used to determine TBS for PSSCH transmission may be realized using one of the reserved bits in the first stage SCI format. The bit field may only be interpreted as a SL PRS overhead when 2^{nd} stage SCI format corresponds to the SCI format for a UE (pre-)configured to receive SL PRS scheduling SL PRS transmission.

For the above embodiments, the new 2^{nd} stage SCI format for a UE (pre-)configured to receive SL PRS which may schedule SL PRS transmission, may also indicate that there is no SL PRS transmission. A separate field in the 2^{nd} stage SCI format or a reserved value(s) of SL PRS resource indication may be used to indicate no SL PRS transmission.

For the above embodiment, to prevent legacy Rel-16/17 device from attempting to decode using the wrong TBS, the 1^{st} stage indication of the SL PRS presence may only be transmitted if 2^{nd} stage SCI format 2-D is used. Alternatively, handling of the potential decoding with wrong TBS assumption may be left up to UE implementation w/o restricting to use the SL PRS OH presence bitfield only to cases when SCI format 2-D is used.

In another embodiment, when the dynamic presence of the SL PRS is signaled in the 1^{st} stage SCI, the number of symbols associated with SL PRS may be removed from the resource calculation of the 2^{nd} stage SCI, i.e., 2^{nd} stage SCI may be independent of SL PRS presence, that would allow 2^{nd} stage SCI decoding before knowledge of SL PRS presence.

In another embodiment, when PSSCH TBS calculation takes into account SL PRS resources considering either a dynamically signaled or a (pre)-configured parameter, subtraction of SL PRS resource elements may be performed in any of the following ways:
Removing all OFDM symbols with SL PRS from the symbols used for PSSCH transmission.
Per PRB removing of Res from the per PRB PSSCH RE calculation. The number of removed Res may either depend on the SL PRS configuration or be (pre-)configured per resource pool. Note to balance the cases with and without SL PRS, system profiling should have the option to (pre-) configure associated values for each potential SL PRS configuration.
Removal of the actual number of SL PRS Res from PSSCH Res.

In one example of this embodiment, the following text in Clause 8.1.3.2 in 3GPP TS 38.214 [2] may be updated with red color for TBS determination for PSSCH transmission.

The UE shall first determine the number of Res (N_{RE}) within the slot.
A UE first determines the number of Res allocated for PSSCH within a PRB

$$( {N}_{RE}^{′} )$$

by

$${N}_{RE}^{′} = {N}_{sc}^{RB} ( {N}_{symb}^{sh} - {N}_{symb}^{PSFCH} - {N}_{symb}^{SL - PRS} ) - {N}_{oh}^{PRB} - {N}_{RE}^{DMRS} ,$$

where

$${N}_{sc}^{RB} = 12$$

is the number of subcarriers in a physical resource block,

$${N}_{symb}^{sh} = sl - LengthSymbols - 2 ,$$

where sl-LengthSymbols is the number of sidelink symbols within the slot provided by higher layers,

$${N}_{symb}^{PSFCH} = 3$$

if ‘PSFCH overhead indication’ field of SCI format 1-A indicates “1”, and

$${N}_{symb}^{PSFCH} = 0 otherwise ,$$

if higher layer parameters sl-PSFCH-Period is 2 or 4. If higher layer parameter sl-PSFCH-Period is 0,

$${N}_{symb}^{PSFCH} = 0 .$$

If higher layer parameter sl-PSFCH-Period is 1,

$${N}_{symb}^{PSFCH} = 3 .$$

$${N}_{symb}^{SL - PRS}$$

is the number of symbols of SL PRS transmission of the PRS overhead indication field of SCI format 1-A indicates “1”, and

$${N}_{symb}^{SL - PRS} = 0$$

otherwise or the number of symbols used for SL PRS as indicated by the SL PRS resource indicator in the new 2^{nd} stage SCI format.

$${N}_{oh}^{PRB}$$

is the overhead given by higher layer parameter sl-X-Overhead,

$${N}_{RE}^{DMRS}$$

is given by Table 8.1.3.2-1 according to higher layer parameter sl-PSSCH-DMRS-TimePatternList.

In another example of this embodiment, the following text in Clause 8.1.3.2 in 3GPP TS 38.214 [2] may be updated with red color for TBS determination for PSSCH transmission.

The UE shall first determine the number of Res (N_{RE}) within the slot.
A UE first determines the number of Res allocated for PSSCH within a PRB

$$( {N}_{R E}^{′} )$$

by

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} - {N}_{oh}^{SL - PRS} ,$$

where

$${N}_{sc}^{RB} = 12$$

is the number of subcarriers in a physical resource block,

$${N}_{symb}^{sh} = sl - LengthSymbols - 2 ,$$

where sl-LengthSymbols is the number of sidelink symbols within the slot provided by higher layers,

$${N}_{s y m b}^{P S F C H} = 3$$

if ‘PSFCH overhead indication’ field of SCI format 1-A indicates “1”, and

$${N}_{s y m b}^{P S F C H} = 0 otherwise ,$$

if higher layer parameter sl-PSFCH-Period is 2 or 4. If higher layer parameter sl-PSFCH-Period is 0,

$${N}_{s y m b}^{P S F C H} = 0 .$$

If higher layer parameter sl-PSFCH-Period is 1,

$${N}_{s y m b}^{P S F C H} = 3 .$$

$${N}_{o h}^{P R B}$$

is the overhead given by higher layer parameter sl-X-Overhead,

$${N}_{R E}^{D M R S}$$

is given by Table 8.1.3.2-1 according to higher layer parameter sl-PSSCH-DMRS-TimePatternList, DMRS-TimePatternList,

$${N}_{o h}^{S L - P R S}$$

is the per PRB overhead given by the higher layer parameter sl-SL PRS-Overhead.

In another example of this embodiment, the following text in Clause 8.1.3.2 in GPP TS 38.214 [2] may be updated with red color for TBS determination for PSSCH transmission.
A UE determines the total number of Res allocated for PSSCH (N_{RE}) by

$${N}_{RE} = {N}_{RE}^{′} \cdot {n}_{PRB} - {N}_{RE}^{SCI , 1} - {N}_{RE}^{SCI , 2} - {N}_{RE}^{SL - PRS} ,$$

where
n_{PRB} is the total number of allocated PRBs for the PSSCH,

$${N}_{R E}^{SCI , 1}$$

is the total number of Res occupied by the PSCCH and PSCCH DM-RS.

$${N}_{R E}^{SCI , 2}$$

is the number of coded modulation symbols generated for 2^{nd}-stage SCI transmission (prior to duplication for the 2^{nd} layer, if present) according to Clause 8.4.4 of [5, TS 38.212], with the assumption of γ=0,

$${N}_{R E}^{S L - P R S}$$

is the total number of Res occupied by the SL PRS.

As a further extension, the number of SL PRS symbols for the TBS determination of PSSCH can be determined in accordance with the minimum or maximum number of symbols for SL PRS among all the SL PRS resources which is configured in a shared SL PRS resource pool.

In another option, the number of SL PRS symbols for the TBS determination of PSSCH can be (pre-)configured for a shared SL PRS resource pool. In this case, when dynamic indication of presence of SL PRS in a shared SL PRS resource pool, TBS of PSSCH can be determined accordingly based on the aforementioned embodiments.

In another option, the number of PSSCH symbols used for the TBS determination may be (pre)-configured per resource pool. Further, this assumption on number of PSSCH symbols may only apply to the case wherein SCI format 2-D (SCI with the presence of SL PRS) is used.

In an example of the embodiment, the indication of absence/presence of SL-SCH in scheduled PSSCH and the indication of assumption of SL PRS overhead for TBS determination of PSSCH are indicated by a single bit that is realized using one of the reserved bits in a first stage SCI format. That is, if the assumption of SL PRS overhead for TBS determination of PSSCH is indicated, it is assumed that SL-SCH is included in the PSSCH, and else, otherwise.

In another example of the embodiment, a UE may be (pre-)configured as part of the SL resource pool configuration if a scheduled PSSCH may not include SL-SCH and only carry the second stage SCI when multiplexed with SL PRS in a slot. In this case, dynamic indication of absence or presence of SL-SCH in scheduled PSSCH using one of the reserved bits in the first stage SCI format may not be used. The same or a separate (pre-) configuration to a UE, as part of the SL resource pool configuration, may also indicate if the TBS of a scheduled PSSCH is to be determined assuming SL PRS overhead.

In another embodiment, if and how the SL PRS resource should be taken into account for the TBS calculation is signalled as part of the 2^{nd} stage format. In some aspects, a codepoint for 2^{nd} stage SCI format indication in the 1^{st} stage SCI with “11” may be used to indicate the new 2^{nd} stage SCI format, e.g., SCI format 2-D.

In another embodiment, a first receiving UE may not expect the same TB (with a given HARQ ID) to be re-transmitted by a second UE with different SL PRS multiplexing assumption from the initial transmission or other (re-)transmissions of this TB, i.e., a first receiving UE may expect either all (re-)transmission have SL PRS or all (re-)transmission do not have PRS.

In another embodiment, a UE is not expected to (re-)transmit a TB with different SL PRS multiplexing assumption from the initial transmission or other (re-)transmissions of this TB.

In another embodiment, source ID and destination ID for SL communication may be same or different from the source ID and destination ID for SL positioning, respectively.

In one option, when different source ID and destination ID are used for SL communication and SL positioning, association between source ID and destination for SL communication and SL positioning may be defined.

In this case, for shared SL PRS resource pool, when SL-SCH is carried by PSSCH and SL PRS is scheduled in the shared SL PRS resource pool that is associated with the PSSCH, source ID and destination ID for SL communication may be included in the second stage SCI as the source ID and destination ID for both SL communication and SL positioning.

Alternatively, for shared SL PRS resource pool, when SL-SCH is carried by PSSCH and SL PRS is scheduled in the shared SL PRS resource pool that is associated with the PSSCH, source ID and destination ID for SL positioning may be included in the second stage SCI as the source ID and destination ID for both SL communication and SL positioning.

Alternatively, for shared SL PRS resource pool, when SL-SCH is not carried by PSSCH and SL PRS is scheduled in the shared SL PRS resource pool that is associated with the PSSCH, source ID and destination ID for SL positioning may be included in the second stage SCI.

In another option, when different source ID and destination ID are used for SL communication and SL positioning, and when SL-SCH is carried by PSSCH and SL PRS is scheduled in the shared SL PRS resource pool that is associated with the PSSCH for a shared SL PRS resource pool, source ID and destination ID which are included in the second stage SCI may be defined as a function of source ID and destination ID for both SL communication and SL positioning.

In one example, an “AND”, “OR” or “XOR” operation may be applied for source ID and destination ID for SL communication and SL positioning to derive the source ID and destination ID indicated in the second stage SCI. Further, a receiving UE may assume a same transmitting UE irrespective of whether source IDs for SL communication and for SL positioning are same or different. In another example, a receiving UE may assume same transmitting and receiving UEs, respectively, irrespective of whether source and destination IDs, respectively, for SL communication and for SL positioning are same or different.

In another embodiment, if SL PRS is indicated as present in a slot and SCI format 1-A in the same slot indicates reservation of one or more slots in future, then SL PRS may be assumed as present in the indicated one or more future reserved slots that are determined in accordance with the time resource assignment in the SCI format 1-A.

In another embodiment, one field can be included in the SCI format 2-D to indicate whether SL PRS transmissions are present in one or more future reserved slots. The future reserved slots may be determined in accordance with the time resource assignment in the SCI format 1-A.

In an example, when the maximum number of reserved resources or sl-MaxNumPerReserve is 2, one bit indication may be included in the SCI format 2-D to indicate whether SL PRS transmission is present in a future reserved slot. In another example, when the maximum number of reserved resources or sl-MaxNumPerReserve is 3, two-bit indication may be included in the SCI format 2-D to indicate whether SL PRS transmission is present in two future reserved slots. In yet another example, when the maximum number of reserved resources or sl-MaxNumPerReserve is 2 or 3, one bit indication may be included in the SCI format 2-D to indicate whether SL PRS transmission is present in the one or two future reserved slots.

In another embodiment, one field can be included in the SCI format 2-D to indicate one or more SL PRS resources in one or more future reserved slots. The future reserved slots may be determined in accordance with the time resource assignment in the SCI format 1-A.

### Phase Tracking Reference Signal (PT-RS) Mapping in a Shared SL PRS Resource Pool

Embodiments of PT-RS mapping in a shared SL PRS resource pool are provided as follows:

In one embodiment, when PT-RS resource element collides with SL PRS symbol in a shared SL PRS resource pool, the PT-RS mapping is restarted and shifted to the next available symbol. In particular, the same PT-RS mapping for PSSCH demodulation reference signal (DMRS) is applied for SL PRS.

The following text in Clause 8.4.1.2.2 in 3GPP TS 38.211 [3] can be updated with red color as follows:

The set of time indices l defined relative to the start of the PSSCH allocation is defined by
1. set i=0 and l_{ref}=0
2. if any symbol in the interval max (l_{ref}+(i−1)L_{PT-RS}+1, l_{ref}), . . . , l_{ref}+iL_{PT-RS} overlaps with a symbol used for DM-RS according to clause 8.4.1.1.2 and SL PRS according to clause 8.4.1.6
   set i=1
   set l_{ref} to the symbol index of the DM-RS symbol or SL PRS symbol
   repeat from step 2 as long as l_{ref}+iL_{PT-RS} is inside the PSSCH allocation
3. add l_{ref}+iL_{PT-RS} to the set of time indices for PT-RS
4. increment i by one
5. repeat from step 2 above as long as l_{ref}+iL_{PT-RS} is inside the PSSCH allocation where L_{PT-RS}∈{1,2,4} is given by clause 8.4.3 of [6, TS 38.214].

In another embodiment, when PT-RS resource element collides with SL PRS symbol in a shared SL PRS resource pool, the PT-RS is dropped by puncturing PSSCH PT-RS. In addition, the legacy PT-RS mapping in accordance with DM-RS symbol can be reused.

The following text in Clause 8.4.1.2.2 in 3GPP TS 38.211 [3] can be updated with red color as follows:

The PSSCH PT-RS shall be mapped to resource elements according to

$$[ \begin{matrix}{a}_{k , l}^{( {p}_{0} , μ )} \\ ⋮ \\ {a}_{k , l}^{( {p}_{ρ - 1} , μ )}\end{matrix} ] = {β}_{DMRS}^{PSSCH} W [ \begin{matrix}{r}^{( {\tilde{p}}_{0} )} ( 2 n + {k}^{′} ) \\ ⋮ \\ {r}^{( {\tilde{p}}_{υ - 1} )} ( 2 n + {k}^{′} )\end{matrix} ]$$

$$k = 4 n + 2 {k}^{′} + Δ$$

when all the following conditions are fulfilled
   l is within the OFDM symbols allocated for the PSSCH transmission;
   resource element (k, l) is not used for PSCCH, nor DM-RS associated with PSSCH, nor SL PRS in a resource pool that is common for PSSCH and SL PRS transmission;
   k′ and Δ correspond to \tilde{p}₀, . . . , \tilde{p}_{υ-1}

### <Unchanged Text Omitted>

PSSCH PT-RS shall not be mapped to resource elements containing PSCCH or PSCCH DMRS or SL PRS by puncturing PSSCH PT-RS.

### REFERENCE

[1] 3GPP TS 38.212. V17.4.0, “Multiplexing and channel coding”
[2] 3GPP TS 38.214. V17.4.0, “NR: Physical layer procedures for data”
[3] 3GPP TS 38.211. V17.4.0, “NR: Physical layer procedures for data”

### SYSTEMS AND IMPLEMENTATIONS

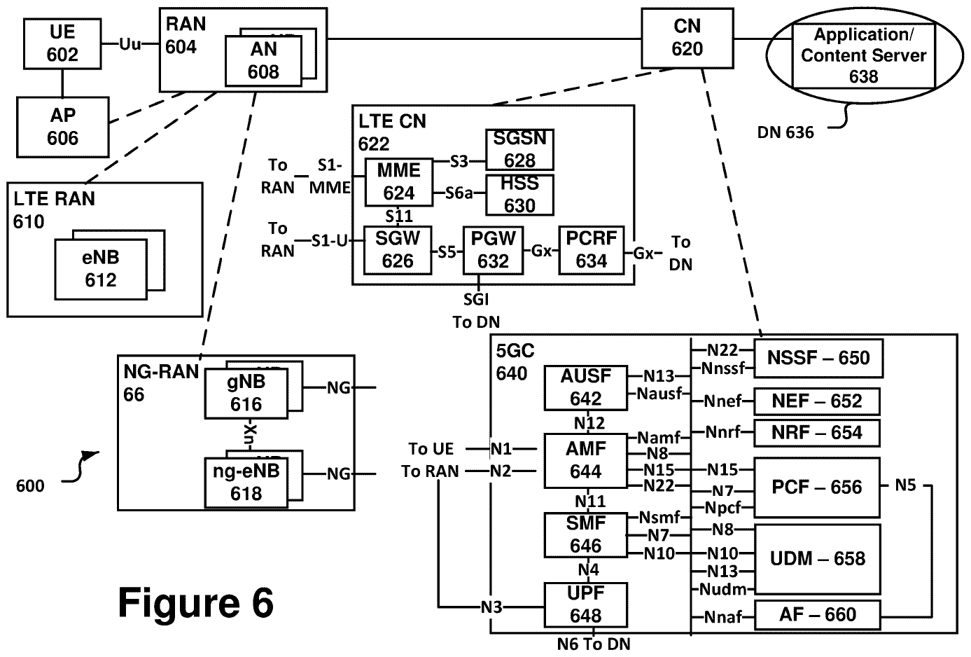

FIGS. 6-9 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics:

SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3^{rd} party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

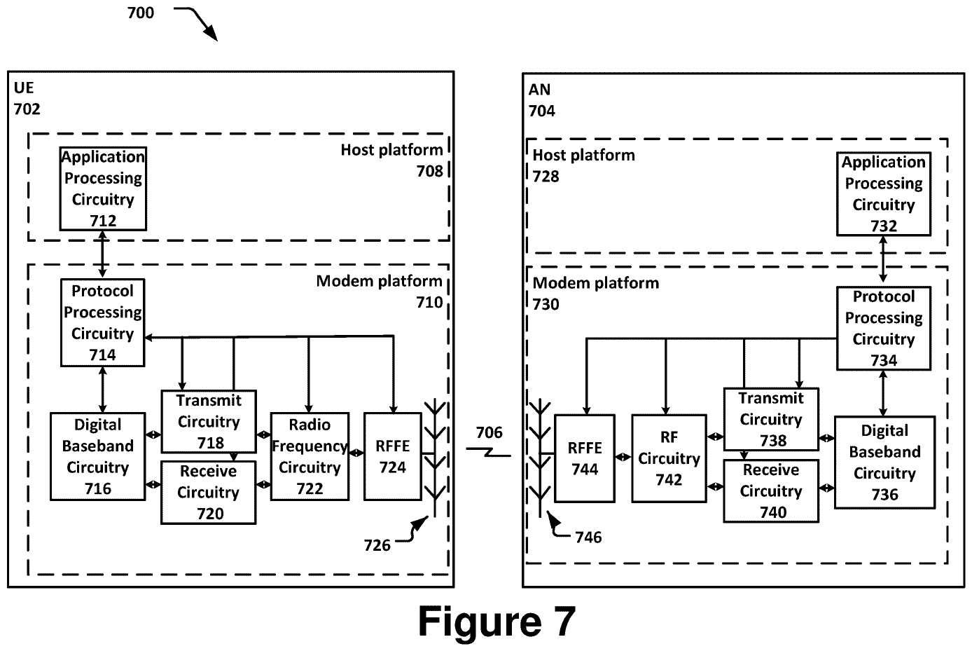

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHz frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

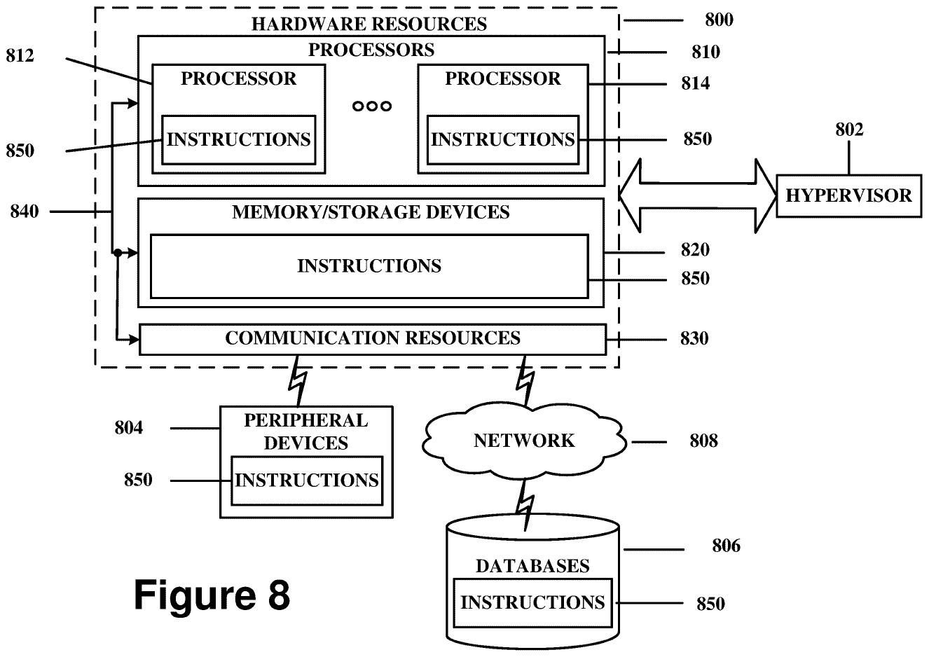

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

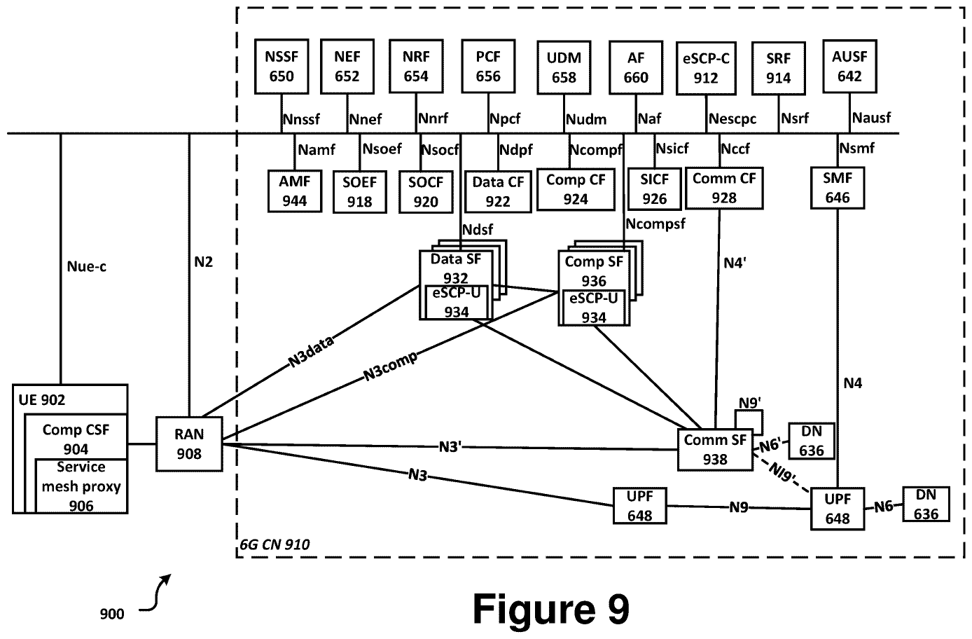

FIG. 9 illustrates a network 900 in accordance with various embodiments. The network 900 may operate in a matter consistent with 3GPP technical specifications or technical reports for 6G systems. In some embodiments, the network 900 may operate concurrently with network 600. For example, in some embodiments, the network 900 may share one or more frequency or bandwidth resources with network 600. As one specific example, a UE (e.g., UE 902) may be configured to operate in both network 900 and network 600. Such configuration may be based on a UE including circuitry configured for communication with frequency and bandwidth resources of both networks 600 and 900. In general, several elements of network 900 may share one or more characteristics with elements of network 600. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 602. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 606 as described with respect to FIG. 6. Additionally, although not specifically shown in FIG. 9, in some embodiments the RAN 908 may include one or more ANss such as AN 608 as described with respect to FIG. 6. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 650, NEF 652, NRF 654, PCF 656, UDM 658, AF 660, SMF 646, and AUSF 642. The 6G CN 910 may additional include UPF 648 and DN 636 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlying computing infrastructure for computing resource management, etc., Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 646 and UPF 648, which were described with respect to a 5G system in FIG. 6. The upgrades provided by the Comm CF 928 and the Comm SF 938 may enable service-aware transport. For legacy (e.g., 4G or 5G) data transport, SMF 646 and UPF 648 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 654, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 644, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

### EXAMPLE PROCEDURES

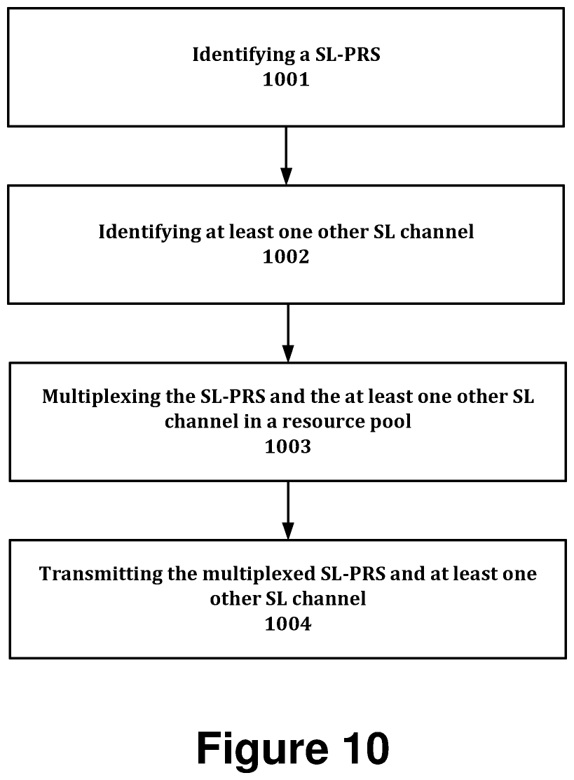

In some embodiments, the electronic device(s), network(s), system(s), chip(s) or component(s), or portions or implementations thereof, of FIGS. 6-9, or some other figure herein, may be configured to perform one or more processes, techniques, or methods as described herein, or portions thereof. One such process is depicted in FIG. 10. The process of FIG. 10 may include or relate to include a method to be performed by a user equipment (UE), one or more elements of a UE, and/or an electronic device that includes and/or implements a UE. The process may include identifying, at 1001, a sidelink positioning reference signal (SL PRS); identifying, at 1002, at least one other sidelink (SL) channel; multiplexing, at 1003, the SL PRS and the at least one other SL channel in a resource pool; and transmitting, at 1004, the multiplexed SL PRS and at least one other SL channel.

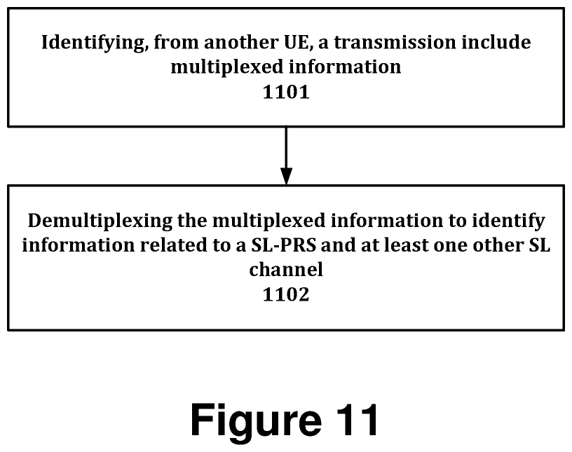

Another such process is depicted in FIG. 11. The process of FIG. 11 may include or relate to a method to be performed by a user equipment (UE), one or more elements of a UE, and/or an electronic device that includes and/or implements a UE. The process may include identifying, at 1101 from another user equipment (UE), a transmission including multiplexed information; and demultiplexing, at 1102, the multiplexed information to identify information related to a sidelink positioning reference signal (SL PRS) and at least one other sidelink (SL) channel.

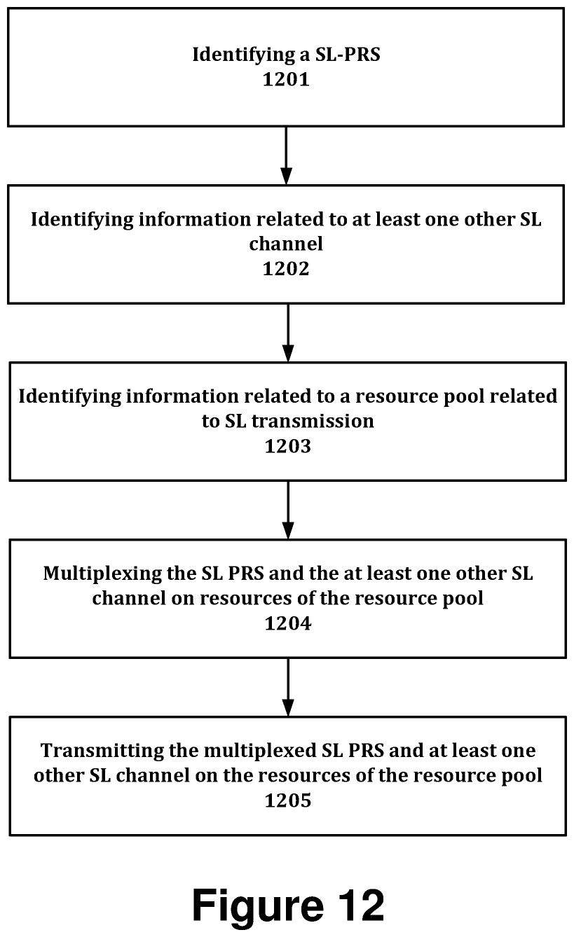

Another such process is depicted in FIG. 12. The process of FIG. 12 may include or relate to a method to be performed by a user equipment (UE), one or more elements of a UE, and/or an electronic device that includes and/or implements a UE. The process may include identifying, at 1201, a sidelink positioning reference signal (SL PRS); identifying, at 1202, information related to at least one other sidelink (SL) channel; identifying, at 1203, information related to a resource pool related to SL transmission; multiplexing, at 1204, the SL PRS and the at least one other SL channel on resources of the resource pool; and facilitating, at 1205, transmission of the multiplexed SL PRS and at least one other SL channel on the resources of the resource pool.

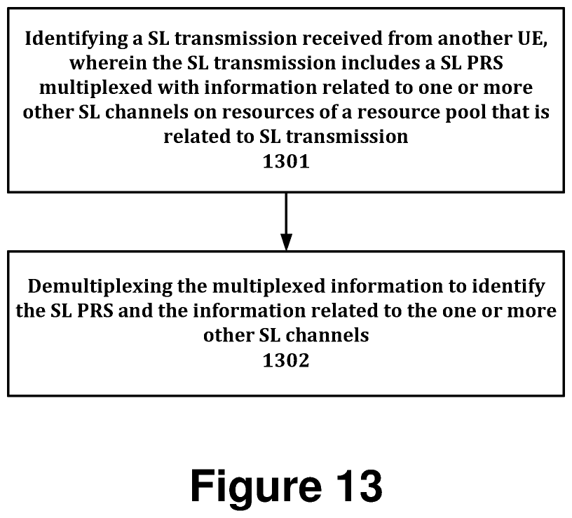

Another such process is depicted in FIG. 13. The process of FIG. 13 may include or relate to a method to be performed by a user equipment (UE), one or more elements of a UE, and/or an electronic device that includes and/or implements a UE. The process may include identifying, at 1301, a sidelink (SL) transmission received from another UE, wherein the SL transmission includes a sidelink positioning reference signal (SL PRS) multiplexed with information related to one or more other SL channels on resources of a resource pool that is related to SL transmission; and demultiplexing, at 1302, the multiplexed information to identify the SL PRS and the information related to the one or more other SL channels.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the system and method of wireless communication for a fifth generation (5G) or new radio (NR) system:
Multiplexed, by a UE, a sidelink positioning reference signal (SL PRS) and other SL channels and signals in a Time Division Multiplexing (TDM) manner in a resource pool;
Transmitted, by the UE, the SL PRS and other SL channels and signals in the resource pool,

Example 2 may include the method of example 1, and/or some other example herein, wherein the other SL channels and signals may include at least one of physical sidelink control channel (PSCCH), physical sidelink shared channel (PSSCH) and associated demodulation reference signal (DMRS) transmission

Example 3 may include the method of example 1, and/or some other example herein, wherein the resource pool may be a dedicated SL PRS resource pool for SL PRS transmission and/or a shared SL PRS resource pool for both SL communication and SL PRS transmission.

Example 4 may include the method of example 1, and/or some other example herein, wherein SL PRS can be multiplexed with PSCCH and PSSCH and associated DMRS in a resource pool in a TDM manner.

Example 5 may include the method of example 1, and/or some other example herein, wherein one bit field may be included in the first stage sidelink control information (SCI) to indicate whether SL-SCH is carried by PSSCH

Example 6 may include the method of example 1, and/or some other example herein, wherein the PSSCH carrying the second stage SCI may be only allocated in the symbols where PSCCH is located, and occupies the remaining resource that is not allocated for PSCCH transmission in the subband(s) for PSSCH-PSCCH transmissions, which is indicated in the first stage SCI

Example 7 may include the method of example 1, and/or some other example herein, wherein the duration of a PSSCH multiplexed with SL PRS in a slot may be shorter than the minimum duration of PSCCH defined for the SL BWP

Example 8 may include the method of example 1, and/or some other example herein, wherein the DMRS associated with such a PSSCH may be limited to a single DMRS symbol and located in the first symbol of PSSCH transmission after AGC symbol

Example 9 may include the method of example 1, and/or some other example herein, wherein if DMRS is not present in the symbols where PSCCH is located, DMRS symbol may be inserted right after the PSCCH symbols

Example 10 may include the method of example 1, and/or some other example herein, wherein the PSSCH carrying the second stage SCI may be allocated in the symbols where PSCCH is located or the symbols after the PSCCH transmissions

Example 11 may include the method of example 1, and/or some other example herein, wherein the number of symbols allocated for PSSCH transmissions can be determined in accordance with the number of symbols allocated for the resource pool, DMRS associated with PSSCH, PSCCH, SL PRS, automatic gain control (AGC) and guard symbol for Tx and Rx turnaround time.

Example 12 may include the method of example 1, and/or some other example herein, wherein the number of additional symbols allocated for PSSCH after PSCCH transmission can be dynamically indicated in the first stage SCI

Example 13 may include the method of example 1, and/or some other example herein, wherein the field for indication of the number of additional symbols may be located in the reserved bits in the first stage SCI

Example 14 may include the method of example 1, and/or some other example herein, wherein the number of symbols allocated for PSSCH may be determined as the minimum integer number of PSSCH symbols needed to carry the calculated number of REs for 2nd stage SCI

Example 15 may include the method of example 1, and/or some other example herein, wherein one bit indicator in the first stage SCI may be used to indicate whether 0 or N additional symbol is allocated for PSSCH transmission after PSCCH, where value N can be (pre-) configured by higher layers.

Example 16 may include the method of example 1, and/or some other example herein, wherein the determined number of coded modulation symbols generated for 2nd-stage SCI transmission is aligned with the symbol boundary within the sub-channel, which is indicated by the first stage SCI.

Example 17 may include the method of example 1, and/or some other example herein, wherein UE is not expected to be provided with sidelink resource pool configuration that leads to number of required PSSCH symbols to carry 2nd stage SCI together with the number symbols for other configured signals, e.g., SL PRS, PSCCH, PSFCH, AGC, Gap to exceed the configured sidelink slot length indicated via higher layer parameter sl-LengthSymbols.

Example 18 may include the method of example 1, and/or some other example herein, wherein same bandwidth can be allocated for PSSCH, PSCCH and SL PRS transmission; wherein DMRS associated with PSSCH may not be needed

Example 19 may include the method of example 1, and/or some other example herein, wherein the number of symbols for PSSCH or the number of additional symbols for PSSCH after PSCCH can be dynamically indicated in the first stage SCI

Example 20 may include the method of example 1, and/or some other example herein, wherein when SL-SCH is carried by PSSCH, and when SL PRS is scheduled in the shared SL PRS resource pool and associated with PSSCH, transport block size (TBS) may be determined in accordance with the number of symbols allocated for SL PRS transmission.

Example 21 may include the method of example 1, and/or some other example herein, wherein when the dynamic presence of the SL PRS is signaled in the 1st stage SCI, the number of symbols associated with SL PRS are removed from the resource calculation of the 2nd stage SCI.

Example 22 may include the method of example 1, and/or some other example herein, wherein TBS calculation for the case that SL PRS resources are considered is either a dynamic signaled or (pre)-configured parameter removing REs in any of the following ways: Removing OFDM symbols with SL PRS from the symbols used for PSSCH transmission, Per PRB removing REs from the per PRB PSSCH RE calculation, or removal of the actual number of SL PRS REs from PSSCH REs.

Example 23 may include the method of example 1, and/or some other example herein, wherein indication of absence/presence of SL-SCH in scheduled PSSCH and the indication of assumption of SL PRS overhead for TBS determination of PSSCH are indicated by a single bit that is realized using one of the reserved bits in a first stage SCI format.

Example 24 may include the method of example 1, and/or some other example herein, wherein source ID and destination ID for SL communication may be same or different from the source ID and destination ID for SL positioning,

Example 25 may include the method of example 1, and/or some other example herein, wherein when different source ID and destination ID are used for SL communication and SL positioning, association between source ID and destination for SL communication and SL positioning may be defined

Example 26 may include the method of example 1, and/or some other example herein, wherein when different source ID and destination ID are used for SL communication and SL positioning, and when SL-SCH is carried by PSSCH and SL PRS is scheduled in the shared SL PRS resource pool that is associated with the PSSCH for a shared SL PRS resource pool, source ID and destination ID which are included in the second stage SCI may be defined as a function of source ID and destination ID for both SL communication and SL positioning.

Example 27 may include the method of example 1, and/or some other example herein, where the resource determination of the REs for 2nd stage SCI is changed for the update SCI format.

Example 28 may include the method in example 27, and/or some other example herein, where beta offset values indicated in the 1st stage SCI has a different (pre)-configured interpretation determining either a defined number of REs or a percentage of the remaining REs.

Where the REs removed form the PSSCH REs to account for SL PRS are either (pre)-configured or derived from the maximum, minimum, average number of REs used for SL PRS transmission are derived from the (pre)-configured SL PRS transmission options.

Example 29 may include the method in example 27, and/or some other example herein, where for the 2nd stage SCI resource determination a beta offset relative to the spectral efficiency is used.

Example 30 may include the method of example 1, and/or some other example herein, wherein the number of SL PRS symbols for the TBS determination of PSSCH can be determined in accordance with the minimum or maximum number of symbols for SL PRS among all the SL PRS resources which is configured in a shared SL PRS resource pool

Example 31 may include the method of example 1, and/or some other example herein, wherein the number of SL PRS symbols for the TBS determination of PSSCH can be (pre-) configured for a shared SL PRS resource pool

Example 32 may include the method of example 1, and/or some other example herein, wherein if SL PRS is indicated as present in a slot and SCI format 1-A in the same slot indicates reservation of one or more slots in future, then SL PRS may be assumed as present in the indicated one or more future reserved slots that are determined in accordance with the time resource assignment in the SCI format 1-A

Example 33 may include the method of example 1, and/or some other example herein, wherein one field can be included in the SCI format 2-D to indicate whether SL PRS transmissions are present in one or more future reserved slots. The future reserved slots may be determined in accordance with the time resource assignment in the SCI format 1-A.

Example 34 may include the method of example 1, and/or some other example herein, wherein when PT-RS resource element collides with SL PRS symbol in a shared SL PRS resource pool, the PT-RS mapping is restarted and shifted to the next available symbol.

Example 35 may include the method of example 1, and/or some other example herein, wherein when PT-RS resource element collides with SL PRS symbol in a shared SL PRS resource pool, the PT-RS is dropped by puncturing PSSCH PT-RS

Example 36 may include a method to be performed by a user equipment (UE), one or more elements of a UE, and/or an electronic device that includes and/or implements a UE, wherein the method comprises:
identifying a sidelink positioning reference signal (SL PRS);
identifying at least one other sidelink (SL) channel;
multiplexing the SL PRS and the at least one other SL channel in a resource pool; and
transmitting the multiplexed SL PRS and at least one other SL channel.

Example 37 may include the method of example 36, and/or some other example herein, wherein the SL PRS and at least one other SL channel are multiplexed in a TDM manner.

Example 38 may include the method of any of examples 36-37, and/or some other example herein, wherein the at least one other SL channel includes a physical sidelink control channel (PSCCH), physical sidelink shared channel (PSSCH), and/or associated demodulation reference signal (DMRS) transmission.

Example 39 may include the method of any of examples 36-38, and/or some other example herein wherein the resource pool is a dedicated SL PRS resource pool for SL PRS transmission.

Example 40 may include the method of any of examples 36-39, and/or some other example herein, wherein the resource pool is a shared SL PRS resource pool for SL communication and SL PRS transmission.

Example 41 may include a method to be performed by a user equipment (UE), one or more elements of a UE, and/or an electronic device that includes and/or implements a UE, wherein the method comprises:
identifying, from another user equipment (UE), a transmission including multiplexed information; and
demultiplexing the multiplexed information to identify information related to a sidelink positioning reference signal (SL PRS) and at least one other sidelink (SL) channel.

Example 42 may include the method of example 41, and/or some other example herein, wherein the SL PRS and at least one other SL channel are multiplexed in the transmission in a TDM manner.

Example 43 may include the method of any of examples 41-42, and/or some other example herein, wherein the at least one other SL channel includes a physical sidelink control channel (PSCCH), physical sidelink shared channel (PSSCH), and/or associated demodulation reference signal (DMRS) transmission.

Example 44 may include a method to be performed by a user equipment (UE), one or more elements of a UE, and/or an electronic device that includes and/or implements a UE, wherein the method comprises: identifying a sidelink positioning reference signal (SL PRS); identifying at least one other sidelink (SL) channel; identifying a resource pool related to SL transmission; multiplexing the SL PRS and the at least one other SL channel on resources of the resource pool; and transmitting the multiplexed SL PRS and at least one other SL channel on the resources of the resource pool.

Example 45 may include the method of example 44, and/or some other example herein, wherein the SL PRS and at least one other SL channel are multiplexed in a time division multiplexed (TDM) manner.

Example 46 may include the method of any of examples 44-45, and/or some other example herein, wherein the at least one other SL channel includes a physical sidelink control channel (PSCCH) or a physical sidelink shared channel (PSSCH).

Example 47 may include the method of example 46, and/or some other example herein, wherein the method further comprises: multiplexing a demodulation reference signal (DMRS) on resources of the resource pool; and transmitting the DMRS on the resources of the resource pool.

Example 48 may include the method of any of examples 46-47, and/or some other example herein, wherein the method further comprises: multiplexing an automatic gain control (AGC) symbol on resources of the resource pool; and transmitting the AGC symbol on the resources of the resource pool.

Example 49 may include the method of any of examples 44-48, and/or some other example herein, wherein the resource pool is a resource pool that includes resources related to SL PRS transmission and does not include resources related to SL communication.

Example 50 includes the method of any of examples 44-49, and/or some other example herein, wherein the resource pool is a shared SL PRS resource pool that includes resources related to SL communication and resources related to SL PRS transmission.

Example 51 includes a method to be performed by a user equipment (UE), one or more elements of a UE, and/or an electronic device that includes and/or implements a UE, wherein the method comprises: identifying, from another user equipment (UE), a sidelink (SL) transmission that includes a sidelink positioning reference signal (SL PRS) multiplexed with information related to another SL channel on resources of a SL resource pool; and demultiplexing the multiplexed information to identify the SL PRS and the information related to the other SL channel.

Example 52 includes the method of example 51, and/or some other example herein, wherein the SL PRS and at least one other SL channel are multiplexed in a time division multiplexed (TDM) manner.

Example 53 includes the method of any of examples 51-52, and/or some other example herein, wherein the at least one other SL channel includes a physical sidelink control channel (PSCCH) or a physical sidelink shared channel (PSSCH).

Example 54 includes the method of example 53, and/or some other example herein, wherein the transmission further includes a demodulation reference signal (DMRS) multiplexed on resources of the resource pool.

Example 55 includes the method of any of examples 53-54, and/or some other example herein, wherein the transmission further includes an automatic gain control (AGC) symbol multiplexed on resources of the resource pool.

Example 56 includes the method of any of examples 51-55, and/or some other example herein, wherein the resource pool is a resource pool that includes resources related to SL PRS transmission and does not include resources related to SL communication.

Example 57 includes the method of any of examples 51-56, and/or some other example herein, wherein the resource pool is a shared SL PRS resource pool that includes resources related to SL communication and resources related to SL PRS transmission.

Example 58 includes a method to be performed by a user equipment (UE), one or more elements of a UE, and/or one or more electronic devices that include and/or implement a UE, wherein the method comprises: identifying a sidelink positioning reference signal (SL PRS); identifying information related to at least one other sidelink (SL) channel; identifying information related to a resource pool related to SL transmission; multiplexing the SL PRS and the at least one other SL channel on resources of the resource pool; and transmitting the multiplexed SL PRS and at least one other SL channel on the resources of the resource pool.

Example 59 includes the method of example 58, and/or some other example herein, wherein the method further includes multiplexing the SL PRS and at least one other SL channel in a time division multiplexed (TDM) manner.

Example 60 includes the method of any of examples 58-59, and/or some other example herein, wherein the at least one other SL channel includes a physical sidelink control channel (PSCCH) or a physical sidelink shared channel (PSSCH).

Example 61 includes the method of example 60, and/or some other example herein, wherein the method further includes multiplexing, in a time division multiplex (TDM) manner, a demodulation reference signal (DMRS) with the SL PRS on resources of the resource pool; and transmitting the DMRS on the resources of the resource pool.

Example 62 includes the method of any of examples 60-61, and/or some other example herein, wherein the method further comprises multiplexing an automatic gain control (AGC) symbol on resources of the resource pool; and transmitting the AGC symbol on the resources of the resource pool.

Example 63 includes the method of any of examples 58-62, and/or some other example herein, wherein the resource pool is a shared SL PRS resource pool that is used for transmission of both SL PRS and PSSCH.

Example 64 includes the method of example 63, and/or some other example herein, wherein the method further comprises identifying, in a second stage sidelink control information (SCI) format, a number of symbols in a slot used for SL PRS transmission; and determining, based on the number of symbols in the slot, a transport block size of a PSSCH transmission in the shared SL PRS resource pool.

Example 65 includes the method of any of examples 63-64, and/or some other example herein, wherein the method further comprises cancelling transmission of a SL phase tracking reference signal (PT-RS) in symbols related to the SL PRS transmission in the shared SL PRS resource pool.

Example 66 includes the method of any of examples 58-65, and/or some other example herein, wherein the resource pool is a dedicated SL PRS resource pool that is used for transmission of SL PRS and is not configured for transmission of PSSCH.

Example 67 includes a method to be performed by a user equipment (UE), one or more elements of a UE, and/or one or more electronic devices that include and/or implement a UE, wherein the method comprises: identifying a sidelink (SL) transmission received from another UE, wherein the SL transmission includes a sidelink positioning reference signal (SL PRS) multiplexed with information related to one or more other SL channels on resources of a resource pool that is related to SL transmission; demultiplexing the multiplexed information to identify the SL PRS and the information related to the one or more other SL channels.

Example 68 includes the method of example 67, and/or some other example herein, wherein the SL PRS and at least one or more other SL channel are multiplexed in a time division multiplexed (TDM) manner.

Example 69 includes the method of any of examples 67-68, and/or some other example herein, wherein the at least one or more other SL channel includes a physical sidelink control channel (PSCCH) or a physical sidelink shared channel (PSSCH).

Example 70 includes the method of any of examples 67-69, and/or some other example herein, wherein the resource pool is a shared SL PRS resource pool that is used for transmission of both SL PRS and a physical sidelink shared channel (PSSCH).

Example 71 includes the UE of example 70, and/or some other example herein, wherein a transport block size of a PSSCH transmission in the shared SL PRS resource pool is based on a number of symbols in a slot used for SL PRS transmission.

Example 72 includes the method of any of examples 70-71, and/or some other example herein, wherein SL PRS resource pool does not include a SL phase tracking reference signal (PT-RS) in symbols related to the SL PRS transmission.

Example 73 includes the method of any of examples 67-72, and/or some other example herein, wherein the resource pool is a dedicated SL PRS resource pool that is used for transmission of SL PRS and is not configured to be used for transmission of PSSCH.

Example Z01 may include an apparatus comprising means to perform one or more elements of a method described in or related to any of examples 1-73, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-73, or any other method or process described herein.

Example Z03 may include an apparatus comprising logic, modules, or circuitry to perform one or more elements of a method described in or related to any of examples 1-73, or any other method or process described herein.

Example Z04 may include a method, technique, or process as described in or related to any of examples 1-73, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-73, or portions thereof.

Example Z06 may include a signal as described in or related to any of examples 1-73, or portions or parts thereof.

Example Z07 may include a datagram, packet, frame, segment, protocol data unit (PDU), or message as described in or related to any of examples 1-73, or portions or parts thereof, or otherwise described in the present disclosure.

Example Z08 may include a signal encoded with data as described in or related to any of examples 1-73, or portions or parts thereof, or otherwise described in the present disclosure.

Example Z09 may include a signal encoded with a datagram, packet, frame, segment, protocol data unit (PDU), or message as described in or related to any of examples 1-73, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-73, or portions thereof.

Example Z11 may include a computer program comprising instructions, wherein execution of the program by a processing element is to cause the processing element to carry out the method, techniques, or process as described in or related to any of examples 1-73, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third | Network | BFD Beam |
| Generation | AnLF Analytics | Failure Detection |
| Partnership | Logical Function | BLER Block Error |
| Project | ANR Automatic | Rate |
| 4G Fourth | Neighbour Relation | BPSK Binary Phase |
| Generation | AOA Angle of | Shift Keying |
| 5G Fifth | Arrival | BRAS Broadband |
| Generation | AP Application | Remote Access |
| 5GC 5G Core | Protocol, Antenna | Server |
| network | Port, Access Point | BSS Business |
| AC | API Application | Support System |
| Application | Programming Interface | BS Base Station |
| Client | APN Access Point | BSR Buffer Status |
| ACR Application | Name | Report |
| Context Relocation | ARP Allocation and | BW Bandwidth |
| ACK | Retention Priority | BWP Bandwidth Part |
| Acknowledgement | ARQ Automatic | C-RNTI Cell |
| | Repeat Request | Radio Network |
| ACID | AS Access Stratum | Temporary |
| Application | ASP | Identity |
| Client Identification | Application Service | CA Carrier |
| ADRF Analytics Data | Provider | Aggregation, |
| Repository | | Certification |
| Function | ASN.1 Abstract Syntax | Authority |
| AF Application | Notation One | CAPEX CAPital |
| Function | AUSF Authentication | Expenditure |
| AM Acknowledged | Server Function | CBD Candidate |
| Mode | AWGN Additive | Beam Detection |
| AMBR Aggregate | White Gaussian | CBRA Contention |
| Maximum Bit Rate | Noise | Based Random |
| AMF Access and | BAP Backhaul | Access |
| Mobility | Adaptation Protocol | CC Component |
| Management | BCH Broadcast | Carrier, Country |
| Function | Channel | Code, Cryptographic |
| AN Access | BER Bit Error Ratio | Checksum |
| CCA Clear Channel | Mandatory | Network, Cloud |
| Assessment | CMAS Commercial | RAN |
| CCE Control | Mobile Alert Service | CRB Common |
| Channel Element | CMD Command | Resource Block |
| CCCH Common | CMS Cloud | CRC Cyclic |
| Control Channel | Management System | Redundancy Check |
| CE Coverage | CO Conditional | CRI Channel-State |
| Enhancement | Optional | Information |
| CDM Content | COMP Coordinated | Resource |
| Delivery Network | Multi-Point | Indicator, CSI-RS |
| CDMA Code- | CORESET Control | Resource |
| Division Multiple | Resource Set | Indicator |
| Access | COTS Commercial | C-RNTI Cell |
| CDR Charging Data | Off-The-Shelf | RNTI |
| Request | CP Control Plane, | CS Circuit |
| CDR Charging Data | Cyclic Prefix, | Switched |
| Response | Connection | CSCF call |
| CFRA Contention Free | Point | session control function |
| Random Access | CPD Connection | CSAR Cloud Service |
| CG Cell Group | Point Descriptor | Archive |
| CGF Charging | CPE Customer | CSI Channel-State |
| Gateway Function | Premise | Information |
| CHF Charging | Equipment | CSI-IM CSI |
| Function | CPICHCommon Pilot | Interference |
| CI Cell Identity | Channel | Measurement |
| CID Cell-ID (e.g., | CQI Channel | CSI-RS CSI |
| positioning method) | Quality Indicator | Reference Signal |
| CIM Common | CPU CSI processing | CSI-RSRP CSI |
| Information Model | unit, Central | reference signal |
| CIR Carrier to | Processing Unit | received power |
| Interference Ratio | C/R | CSI-RSRQ CSI |
| CK Cipher Key | Command/Resp | reference signal |
| CM Connection | onse field bit | received quality |
| Management, | CRAN Cloud Radio | CSI-SINR CSI |
| Conditional | Access | signal-to-noise and |
| interference | Reference Signal | ED Energy |
| ratio | DN Data network | Detection |
| CSMA Carrier Sense | DNN Data Network | EDGE Enhanced |
| Multiple Access | Name | Datarates for GSM |
| CSMA/CA CSMA | DNAI Data Network | Evolution |
| with collision | Access Identifier | (GSM Evolution) |
| avoidance | | EAS Edge |
| CSS Common | DRB Data Radio | Application Server |
| Search Space, Cell- | Bearer | EASID Edge |
| specific Search | DRS Discovery | Application Server |
| Space | Reference Signal | Identification |
| CTF Charging | DRX Discontinuous | ECS Edge |
| Trigger Function | Reception | Configuration Server |
| CTS Clear-to-Send | DSL Domain | ECSP Edge |
| CW Codeword | Specific Language. | Computing Service |
| CWS Contention | Digital | Provider |
| Window Size | Subscriber Line | EDN Edge |
| D2D Device-to- | DSLAM DSL | Data Network |
| Device | Access Multiplexer | EEC Edge |
| DC Dual | DwPTS | Enabler Client |
| Connectivity, Direct | Downlink Pilot | EECID Edge |
| Current | Time Slot | Enabler Client |
| DCI Downlink | E-LAN Ethernet | Identification |
| Control | Local Area Network | EES Edge |
| Information | E2E End-to-End | Enabler Server |
| DF Deployment | EAS Edge | EESID Edge |
| Flavour | Application Server | Enabler Server |
| DL Downlink | ECCA extended clear | Identification |
| DMTF Distributed | channel | EHE Edge |
| Management Task | assessment, | Hosting Environment |
| Force | extended CCA | EGMF Exposure |
| DPDK Data Plane | ECCE Enhanced | Governance |
| Development Kit | Control Channel | Management |
| DM-RS, DMRS | Element, | Function |
| Demodulation | Enhanced CCE | EGPRS |
| Enhanced | ETSI European | Channel |
| GPRS | Telecommunications | FAUSCH Fast |
| EIR Equipment | Standards | Uplink Signalling |
| Identity Register | Institute | Channel |
| eLAA enhanced | ETWS Earthquake and | FB Functional |
| Licensed Assisted | Tsunami Warning | Block |
| Access, | System | FBI Feedback |
| enhanced LAA | eUICC embedded | Information |
| EM Element | UICC, embedded | FCC Federal |
| Manager | Universal | Communications |
| eMBB Enhanced | Integrated Circuit | Commission |
| Mobile | Card | FCCH Frequency |
| Broadband | E-UTRA Evolved | Correction CHannel |
| EMS Element | UTRA | FDD Frequency |
| Management System | E-UTRAN Evolved | Division Duplex |
| eNB evolved NodeB, | UTRAN | FDM Frequency |
| E-UTRAN Node B | EV2X Enhanced V2X | Division |
| EN-DC E- | F1AP F1 Application | Multiplex |
| UTRA-NR Dual | Protocol | FDMA Frequency |
| Connectivity | F1-C F1 Control | Division Multiple |
| EPC Evolved Packet | plane interface | Access |
| Core | F1-U F1 User plane | FE Front End |
| EPDCCH | interface | FEC Forward Error |
| enhanced | FACCH Fast | Correction |
| PDCCH, enhanced | Associated Control | FFS For Further |
| Physical | CHannel | Study |
| Downlink Control | FACCH/F Fast | FFT Fast Fourier |
| Cannel | Associated Control | Transformation |
| EPRE Energy per | Channel/Full | feLAA further |
| resource element | rate | enhanced Licensed |
| EPS Evolved Packet | FACCH/H Fast | Assisted |
| System | Associated Control | Access, further |
| EREG enhanced REG, | Channel/Half | enhanced LAA |
| enhanced resource | rate | FN Frame Number |
| element groups | FACH Forward Access | FPGA Field- |
| Programmable Gate | Generation | HFN HyperFrame |
| Array | NodeB | Number |
| FR Frequency | distributed unit | HHO Hard Handover |
| Range | GNSS Global | HLR Home Location |
| FQDN Fully | Navigation Satellite | Register |
| Qualified Domain | System | HN Home Network |
| Name | GPRS General Packet | HO Handover |
| G-RNTI GERAN | Radio Service | HPLMN Home |
| Radio Network | GPSI Generic | Public Land Mobile |
| Temporary | Public Subscription | Network |
| Identity | Identifier | HSDPA High |
| GERAN | GSM Global System | Speed Downlink |
| GSM EDGE | for Mobile | Packet Access |
| RAN, GSM EDGE | Communications, | HSN Hopping |
| Radio Access | Groupe Spécial | Sequence Number |
| Network | Mobile | HSPA High Speed |
| GGSN Gateway GPRS | GTP GPRS | Packet Access |
| Support Node | Tunneling Protocol | HSS Home |
| GLONASS | GTP-UGPRS | Subscriber Server |
| GLObal'naya | Tunnelling Protocol | HSUPA High |
| NAvigatsionnay | for User Plane | Speed Uplink Packet |
| a Sputnikovaya | GTS Go To Sleep | Access |
| Sistema (Engl.: | Signal (related | HTTP Hyper Text |
| Global Navigation | to WUS) | Transfer Protocol |
| Satellite | GUMMEI Globally | HTTPS Hyper |
| System) | Unique MME | Text Transfer Protocol |
| gNB Next | Identifier | Secure (https is |
| Generation NodeB | GUTI Globally | http/1.1 over |
| gNB-CU gNB- | Unique Temporary | SSL, i.e. port 443) |
| centralized unit, Next | UE Identity | I-Block |
| Generation | HARQ Hybrid ARQ, | Information |
| NodeB | Hybrid | Block |
| centralized unit | Automatic | ICCID Integrated |
| gNB-DU gNB- | Repeat Request | Circuit Card |
| distributed unit, Next | HANDO Handover, | Identification |
| IAB Integrated | IP Multimedia | IS In Sync |
| Access and | IMC IMS | IRP Integration |
| Backhaul | Credentials | Reference Point |
| ICIC Inter-Cell | IMEI International | ISDN Integrated |
| Interference | Mobile | Services Digital |
| Coordination | Equipment | Network |
| ID Identity, | Identity | ISIM IM Services |
| identifier | IMGI International | Identity Module |
| IDFT Inverse Discrete | mobile group identity | ISO International |
| Fourier | IMPI IP Multimedia | Organisation for |
| Transform | Private Identity | Standardisation |
| IE Information | IMPU IP Multimedia | ISP Internet Service |
| element | PUblic identity | Provider |
| IBE In-Band | IMS IP Multimedia | IWF Interworking- |
| Emission | Subsystem | Function |
| IEEE Institute of | IMSI International | I-WLAN |
| Electrical and | Mobile | Interworking |
| Electronics | Subscriber | WLAN |
| Engineers | Identity | Constraint |
| IEI Information | IoT Internet of | length of the |
| Element | Things | convolutional |
| Identifier | IP Internet | code, USIM |
| IEIDL Information | Protocol | Individual key |
| Element | Ipsec IP Security, | kB Kilobyte (1000 |
| Identifier Data | Internet Protocol | bytes) |
| Length | Security | kbps kilo-bits per |
| IETF Internet | IP-CAN IP- | second |
| Engineering Task | Connectivity Access | Kc Ciphering key |
| Force | Network | Ki Individual |
| IF Infrastructure | IP-M IP Multicast | subscriber |
| IIOT Industrial | IPv4 Internet | authentication |
| Internet of Things | Protocol Version 4 | key |
| IM Interference | IPv6 Internet | KPI Key |
| Measurement, | Protocol Version 6 | Performance Indicator |
| Intermodulation | IR Infrared | KQI Key Quality |
| Indicator | LMF Location | (TSG T WG3 context) |
| KSI Key Set | Management Function | MAC-IMAC used for |
| Identifier | LOS Line of | data integrity of |
| ksps kilo-symbols | Sight | signalling messages |
| per second | LPLMN Local | (TSG T WG3 context) |
| KVM Kernel Virtual | PLMN | MANO |
| Machine | LPP LTE | Management |
| L1 Layer 1 | Positioning Protocol | and Orchestration |
| (physical layer) | LSB Least | MBMS |
| L1-RSRP Layer 1 | Significant Bit | Multimedia |
| reference signal | LTE Long Term | Broadcast and |
| received power | Evolution | Multicast |
| L2 Layer 2 (data | LWA LTE-WLAN | Service |
| link layer) | aggregation | MBSFN |
| L3 Layer 3 | LWIP LTE/WLAN | Multimedia |
| (network layer) | Radio Level | Broadcast |
| LAA Licensed | Integration with | multicast |
| Assisted Access | IPsec Tunnel | service Single |
| LAN Local Area | LTE Long Term | Frequency |
| Network | Evolution | Network |
| LADN Local | M2M Machine-to- | MCC Mobile Country |
| Area Data Network | Machine | Code |
| LBT Listen Before | MAC Medium Access | MCG Master Cell |
| Talk | Control | Group |
| LCM LifeCycle | (protocol | MCOT Maximum |
| Management | layering context) | Channel |
| LCR Low Chip Rate | MAC Message | Occupancy |
| LCS Location | authentication code | Time |
| Services | (security/encryption | MCS Modulation and |
| LCID Logical | context) | coding scheme |
| Channel ID | MAC-A MAC | MDAF Management |
| LI Layer Indicator | used for | Data Analytics |
| LLC Logical Link | authentication | Function |
| Control, Low Layer | and key | MDAS Management |
| Compatibility | agreement | Data Analytics |
| Service | Physical Downlink | Terminated, Mobile |
| MDT Minimization of | Control | Termination |
| Drive Tests | CHannel | MTC Machine-Type |
| ME Mobile | MPDSCH MTC | Communications |
| Equipment | Physical Downlink | |
| MeNB master eNB | Shared | MTLF Model Training |
| MER Message Error | CHannel | Logical |
| Ratio | MPRACH MTC | Functions |
| MGL Measurement | Physical Random | mMTCmassive MTC, |
| Gap Length | Access | massive |
| MGRP Measurement | CHannel | Machine-Type |
| Gap Repetition | MPUSCH MTC | Communications |
| Period | Physical Uplink Shared | |
| MIB Master | Channel | MU-MIMO Multi |
| Information Block, | MPLS MultiProtocol | User MIMO |
| Management | Label Switching | MWUS MTC |
| Information Base | MS Mobile Station | wake-up signal, MTC |
| MIMO Multiple Input | MSB Most | WUS |
| Multiple Output | Significant Bit | NACK Negative |
| MLC Mobile | MSC Mobile | Acknowledgement |
| Location Centre | Switching Centre | NAI Network |
| MM Mobility | MSI Minimum | Access Identifier |
| Management | System | NAS Non-Access |
| MME Mobility | Information, | Stratum, Non- Access |
| Management Entity | MCH Scheduling | Stratum layer |
| MN Master Node | Information | NCT Network |
| MNO Mobile | MSID Mobile Station | Connectivity |
| Network Operator | Identifier | Topology |
| MO Measurement | MSIN Mobile Station | NC-JT Non- |
| Object, Mobile | Identification | Coherent Joint |
| Originated | Number | Transmission |
| MPBCH MTC | MSISDN Mobile | NEC Network |
| Physical Broadcast | Subscriber ISDN | Capability |
| CHannel | Number | Exposure |
| MPDCCH MTC | MT Mobile | NE-DC NR-E- |
| UTRA Dual | CHannel | NSA Non-Standalone |
| Connectivity | NPDCCH | operation mode |
| NEF Network | Narrowband | NSD Network |
| Exposure Function | Physical | Service Descriptor |
| NF Network | Downlink | NSR Network |
| Function | Control CHannel | Service Record |
| NFP Network | NPDSCH | NSSAINetwork Slice |
| Forwarding Path | Narrowband | Selection |
| NFPD Network | Physical | Assistance |
| Forwarding Path | Downlink | Information |
| Descriptor | Shared CHannel | S-NNSAI Single- |
| NFV Network | NPRACH | NSSAI |
| Functions | Narrowband | NSSF Network Slice |
| Virtualization | Physical Random | Selection Function |
| NFVI NFV | Access CHannel | NW Network |
| Infrastructure | NPUSCH | NWDAF Network |
| NFVO NFV | Narrowband | Data Analytics |
| Orchestrator | Physical Uplink | Function |
| NG Next | Shared CHannel | NWUS Narrowband |
| Generation, Next Gen | NPSS Narrowband | wake-up signal, |
| NGEN-DC NG- | Primary | Narrowband WUS |
| RAN E-UTRA-NR | Synchronization | NZP Non-Zero |
| Dual Connectivity | Signal | Power |
| NM Network | NSSS Narrowband | O&M Operation and |
| Manager | Secondary | Maintenance |
| NMS Network | Synchronization | ODU2 Optical channel |
| Management System | Signal | Data Unit-type 2 |
| N-POP Network Point | NR New Radio, | OFDM Orthogonal |
| of Presence | Neighbour Relation | Frequency Division |
| NMIB, N-MIB | NRF NF Repository | Multiplexing |
| Narrowband MIB | Function | OFDMA |
| NPBCH | NRS Narrowband | Orthogonal |
| Narrowband | Reference Signal | Frequency Division |
| Physical | NS Network | Multiple Access |
| Broadcast | Service | OOB Out-of-band |
| OOS Out of | and Charging Rules | Measurement |
| Sync | Function | PMI Precoding |
| OPEX OPerating | PDCP Packet Data | Matrix Indicator |
| EXpense | Convergence | PNF Physical |
| OSI Other System | Protocol, Packet | Network Function |
| Information | Data Convergence | PNFD Physical |
| OSS Operations | Protocol layer | Network Function |
| Support System | PDCCH Physical | Descriptor |
| OTA over-the-air | Downlink Control | PNFR Physical |
| PAPR Peak-to- | Channel | Network Function |
| Average Power | PDCP Packet Data | Record |
| Ratio | Convergence Protocol | POC PTT over |
| PAR Peak to | PDN Packet Data | Cellular |
| Average Ratio | Network, Public | PP, PTP Point-to- |
| PBCH Physical | Data Network | Point |
| Broadcast Channel | PDSCH Physical | PPP Point-to-Point |
| PC Power Control, | Downlink Shared | Protocol |
| Personal | Channel | PRACH Physical |
| Computer | PDU Protocol Data | RACH |
| PCC Primary | Unit | PRB Physical |
| Component Carrier, | PEI Permanent | resource block |
| Primary CC | Equipment | PRG Physical |
| P-CSCF Proxy | Identifiers | resource block |
| CSCF | PFD Packet Flow | group |
| PCell Primary Cell | Description | 95 ProSe Proximity |
| PCI Physical Cell | P-GW PDN Gateway | Services, |
| ID, Physical Cell | PHICH Physical | Proximity- |
| Identity | hybrid-ARQ indicator | Based Service |
| PCEF Policy and | channel | PRS Positioning |
| Charging | PHY Physical layer | Reference Signal |
| Enforcement | PLMN Public Land | PRR Packet |
| Function | Mobile Network | Reception Radio |
| PCF Policy Control | PIN Personal | PS Packet Services |
| Function | Identification Number | PSBCH Physical |
| PCRF Policy Control | PM Performance | Sidelink Broadcast |
| Channel | QFI QoS Flow ID, | REG Resource |
| PSDCH Physical | QoS Flow | Element Group |
| Sidelink Downlink | Identifier | Rel Release |
| Channel | QoS Quality of | REQ REQuest |
| PSCCH Physical | Service | RF Radio |
| Sidelink Control | QPSK Quadrature | Frequency |
| Channel | (Quaternary) Phase | RI Rank Indicator |
| PSSCH Physical | Shift Keying | RIV Resource |
| Sidelink Shared | QZSS Quasi-Zenith | indicator value |
| Channel | Satellite System | RL Radio Link |
| PSFCH physical | RA-RNTI Random | RLC Radio Link |
| sidelink feedback | Access RNTI | Control, Radio |
| channel | RAB Radio Access | Link Control |
| PSCell Primary SCell | Bearer, Random | layer |
| PSS Primary | Access Burst | RLC AM RLC |
| Synchronization | RACH Random Access | Acknowledged Mode |
| Signal | Channel | RLC UM RLC |
| PSTN Public Switched | RADIUS Remote | Unacknowledged |
| Telephone Network | Authentication Dial | Mode |
| PT-RS Phase-tracking | In User Service | RLF Radio Link |
| reference signal | RAN Radio Access | Failure |
| PTT Push-to-Talk | Network | RLM Radio Link |
| PUCCH Physical | RAND RANDom | Monitoring |
| Uplink Control | number (used for | RLM-RS |
| Channel | authentication) | Reference |
| PUSCH Physical | RAR Random Access | Signal for RLM |
| Uplink Shared | Response | RM Registration |
| Channel | RAT Radio Access | Management |
| QAM Quadrature | Technology | RMC Reference |
| Amplitude | RAU Routing Area | Measurement Channel |
| Modulation | Update | RMSI Remaining |
| QCI QoS class of | RB Resource block, | MSI, Remaining |
| identifier | Radio Bearer | Minimum |
| QCL Quasi co- | RBG Resource block | System |
| location | group | Information |
| RN Relay Node | Time | SCell Secondary Cell |
| RNC Radio Network | Rx Reception, | SCEF Service |
| Controller | Receiving, Receiver | Capability Exposure |
| RNL Radio Network | S1AP S1 Application | Function |
| Layer | 40 Protocol | SC-FDMA Single |
| RNTI Radio Network | S1-MME S1 for | Carrier Frequency |
| Temporary | the control plane | Division |
| Identifier | S1-U S1 for the user | Multiple Access |
| ROHC RObust Header | plane | SCG Secondary Cell |
| Compression | S-CSCF serving | Group |
| RRC Radio Resource | CSCF | SCM Security |
| Control, Radio | S-GW Serving | Context |
| Resource Control | Gateway | Management |
| layer | S-RNTI SRNC | SCS Subcarrier |
| RRM Radio Resource | Radio Network | Spacing |
| Management | Temporary | SCTP Stream Control |
| RS Reference | Identity | Transmission |
| Signal | S-TMSI SAE | Protocol |
| RSRP Reference | Temporary Mobile | SDAP Service Data |
| Signal Received | Station | Adaptation |
| Power | Identifier | Protocol, |
| RSRQ Reference | SA Standalone | Service Data |
| Signal Received | operation mode | Adaptation |
| Quality | SAE System | Protocol layer |
| RSSI Received Signal | Architecture | SDL Supplementary |
| Strength | Evolution | Downlink |
| Indicator | SAP Service Access | SDNF Structured Data |
| RSU Road Side Unit | Point | Storage Network |
| RSTD Reference | SAPD Service Access | Function |
| Signal Time | Point Descriptor | SDP Session |
| difference | SAPI Service Access | Description Protocol |
| RTP Real Time | Point Identifier | SDSF Structured Data |
| Protocol | SCCS econdary | Storage Function |
| RTS Ready-To-Send | Component Carrier, | SDT Small Data |
| RTT Round Trip | Secondary CC | Transmission |
| SDU Service Data | Agreement | Identifier |
| Unit | SM Session | SS/PBCH Block |
| SEAF Security | Management | SSBRI SS/PBCH |
| Anchor Function | SMF Session | Block Resource |
| SeNB secondary eNB | Management Function | Indicator, |
| SEPP Security Edge | SMS Short Message | Synchronization |
| Protection Proxy | Service | Signal Block |
| SFI Slot format | SMSF SMS Function | Resource |
| indication | SMTC SSB-based | Indicator |
| SFTD Space- | Measurement Timing | SSC Session and |
| Frequency Time | Configuration | Service |
| Diversity, SFN | SN Secondary | Continuity |
| and frame timing | Node, Sequence | SS-RSRP |
| difference | Number | Synchronization |
| SFN System Frame | SoC System on Chip | Signal based |
| Number | SON Self-Organizing | Reference |
| SgNB Secondary gNB | Network | Signal Received |
| SGSN Serving GPRS | SpCell Special Cell | Power |
| Support Node | SP-CSI-RNTISemi- | SS-RSRQ |
| S-GW Serving | Persistent CSI RNTI | Synchronization |
| Gateway | SPS Semi-Persistent | Signal based |
| SI System | Scheduling | Reference |
| Information | SQN Sequence | Signal Received |
| SI-RNTI System | number | Quality |
| Information RNTI | SR Scheduling | SS-SINR |
| SIB System | Request | Synchronization |
| Information Block | SRB Signalling | Signal based Signal |
| SIM Subscriber | Radio Bearer | to Noise and |
| Identity Module | SRS Sounding | Interference Ratio |
| SIP Session | Reference Signal | SSS Secondary |
| Initiated Protocol | SS Synchronization | Synchronization |
| SiP System in | Signal | Signal |
| Package | SSB Synchronization | SSSG Search Space |
| SL Sidelink | Signal Block | Set Group |
| SLA Service Level | SSID Service Set | SSSIF Search Space |
| Set Indicator | TE Terminal | Radio Network |
| SST Slice/Service | Equipment | Temporary |
| Types | TEID Tunnel End | Identity |
| SU-MIMO Single | Point Identifier | UART Universal |
| User MIMO | TFT Traffic Flow | Asynchronous |
| SUL Supplementary | Template | Receiver and |
| Uplink | TMSI Temporary | Transmitter |
| TA Timing | Mobile | UCI Uplink Control |
| Advance, Tracking | Subscriber | Information |
| Area | Identity | UE User Equipment |
| TAC Tracking Area | TNL Transport | UDM Unified Data |
| Code | Network Layer | Management |
| TAG Timing | TPC Transmit Power | UDP User Datagram |
| Advance Group | Control | Protocol |
| TAI | TPMI Transmitted | UDSF Unstructured |
| Tracking Area | Precoding Matrix | Data Storage Network |
| Identity | Indicator | Function |
| TAU Tracking Area | TR Technical | UICC Universal |
| Update | Report | Integrated Circuit |
| TB Transport Block | TRP, TRxP | Card |
| TBS Transport Block | Transmission | UL Uplink |
| Size | Reception Point | UM |
| TBD To Be Defined | TRS Tracking | Unacknowledged |
| TCI Transmission | Reference Signal | Mode |
| Configuration | TRx Transceiver | UML Unified |
| Indicator | TS Technical | Modelling Language |
| TCP Transmission | Specifications, | UMTS Universal |
| Communication | Technical | Mobile |
| Protocol | Standard | Telecommunications |
| TDD Time Division | TTI Transmission | System |
| Duplex | Time Interval | UP User Plane |
| TDM Time Division | Tx Transmission, | UPF User Plane |
| Multiplexing | Transmitting, | Function |
| TDMA Time Division | Transmitter | URI Uniform |
| Multiple Access | U-RNTI UTRAN | Resource Identifier |
| URL Uniform | Network | X2-U X2-User plane |
| Resource Locator | VM Virtual | XML extensible |
| URLLC Ultra- | Machine | Markup |
| Reliable and Low | VNF Virtualized | Language |
| Latency | Network Function | XRES Expected user |
| USB Universal Serial | VNFFG VNF | RESponse |
| Bus | Forwarding Graph | XOR eXclusive OR |
| USIM Universal | VNFFGD VNF | ZC Zadoff-Chu |
| Subscriber Identity | Forwarding Graph | ZP Zero Power |
| Module | Descriptor | |
| USS UE-specific | VNFM VNF Manager | |
| search space | VoIP Voice-over-IP, | |
| UTRA UMTS | Voice-over-Internet | |
| Terrestrial Radio | Protocol | |
| Access | VPLMN Visited | |
| UTRAN | Public Land Mobile | |
| Universal | Network | |
| Terrestrial Radio | VPN Virtual Private | |
| Access | Network | |
| Network | VRB Virtual | |
| UwPTS Uplink | Resource Block | |
| Pilot Time Slot | WiMAX | |
| V2I Vehicle-to- | Worldwide | |
| Infrastruction | Interoperability | |
| V2P Vehicle-to- | for Microwave | |
| Pedestrian | Access | |
| V2V Vehicle-to- | WLANWireless Local | |
| Vehicle | Area Network | |
| V2X Vehicle-to- | WMAN Wireless | |
| everything | Metropolitan Area | |
| VIM Virtualized | Network | |
| Infrastructure Manager | WPANWireless | |
| VL Virtual Link, | Personal Area Network | |
| VLAN Virtual LAN, | X2-C X2-Control | |
| Virtual Local Area | plane | |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1. A user equipment (UE) comprising:
memory to:
store a sidelink positioning reference signal (SL PRS);
store information related to at least one other sidelink (SL) channel; and
store information related to a resource pool related to SL transmission; and
one or more processors configured to:
multiplex the SL PRS and the at least one other SL channel on resources of the resource pool; and
facilitate transmission of the multiplexed SL PRS and at least one other SL channel on the resources of the resource pool.

2. The UE of claim 1, wherein the one or more processors are configured to multiplex the SL PRS and at least one other SL channel in a time division multiplexed (TDM) manner.

3. The UE of claim 1, wherein the at least one other SL channel includes a physical sidelink control channel (PSCCH) or a physical sidelink shared channel (PSSCH).

4. The UE of claim 3, wherein the one or more processors are further configured to:
multiplex, in a time division multiplex (TDM) manner, a demodulation reference signal (DMRS) with the SL PRS on resources of the resource pool; and
facilitate transmission of the DMRS on the resources of the resource pool.

5. The UE of claim 3, wherein the one or more processors are further configured to:
multiplex an automatic gain control (AGC) symbol on resources of the resource pool; and
facilitate transmission of the AGC symbol on the resources of the resource pool.

6. The UE of claim 1, wherein the resource pool is a shared SL PRS resource pool that is used for transmission of both SL PRS and PSSCH.

7. The UE of claim 6, wherein the one or more processors are further configured to:
identify, in a second stage sidelink control information (SCI) format, a number of symbols in a slot used for SL PRS transmission; and
determine, based on the number of symbols in the slot, a transport block size of a PSSCH transmission in the shared SL PRS resource pool.

8. The UE of claim 6, wherein the one or more processors are further configured to cancel transmission of a SL phase tracking reference signal (PT-RS) in symbols related to the SL PRS transmission in the shared SL PRS resource pool.

9. The UE of claim 1, wherein the resource pool is a dedicated SL PRS resource pool that is used for transmission of SL PRS and is not configured for transmission of PSSCH.

10. A user equipment (UE) comprising:
memory to store a sidelink (SL) transmission received from another UE, wherein the SL transmission includes a sidelink positioning reference signal (SL PRS) multiplexed with information related to one or more other SL channels on resources of a resource pool that is related to SL transmission; and
one or more processors configured to demultiplex the multiplexed information to identify the SL PRS and the information related to the one or more other SL channels.

11. The UE of claim 10, wherein the SL PRS and at least one or more other SL channel are multiplexed in a time division multiplexed (TDM) manner.

12. The UE of claim 10, wherein the at least one or more other SL channel includes a physical sidelink control channel (PSCCH) or a physical sidelink shared channel (PSSCH).

13. The UE of claim 10, wherein the resource pool is a shared SL PRS resource pool that is used for transmission of both SL PRS and a physical sidelink shared channel (PSSCH).

14. The UE of claim 13, wherein a transport block size of a PSSCH transmission in the shared SL PRS resource pool is based on a number of symbols in a slot used for SL PRS transmission.

15. The UE of claim 13, wherein SL PRS resource pool does not include a SL phase tracking reference signal (PT-RS) in symbols related to the SL PRS transmission.

16. The UE of claim 11, wherein the resource pool is a dedicated SL PRS resource pool that is used for transmission of SL PRS and is not configured to be used for transmission of PSSCH.

17. One or more non-transitory computer-readable media comprising instructions that, upon execution of the instructions by one or more processors of a user equipment (UE), are configured to cause the UE to:
identify a sidelink positioning reference signal (SL PRS);
identify at least one other sidelink (SL) channel;
identify a resource pool related to SL transmission;
multiplex, in a time division multiplexed (TDM) manner, the SL PRS and the at least one other SL channel on resources of the resource pool; and
transmit the multiplexed SL PRS and at least one other SL channel on the resources of the resource pool.

18. The one or more non-transitory computer-readable media of claim 17, wherein the at least one other SL channel includes a physical sidelink control channel (PSCCH).

19. The one or more non-transitory computer-readable media of claim 17, wherein the at least one other SL channel includes a physical sidelink shared channel (PSSCH).

20. The one or more non-transitory computer-readable media of claim 19, wherein the instructions are further to cause the UE to:
multiplex a demodulation reference signal (DMRS) with SL PRS in a TDM manner, or an automatic gain control (AGC) symbol on resources of the resource pool; and
transmit the DMRS or the AGC symbol on the resources of the resource pool.
